(19) United States
(12) Patent Application Publication
(10) Pub. No.: US 2013/0310130 A1
(43) Pub. Date: Nov. 21, 2013

(54) METHODS AND SYSTEMS OF PROVIDING LOTTERY POOL SETUP, MANAGEMENT, AND WINNING DISTRIBUTION

(71) Applicant: Vinay Kumar Asthana, (US)

(72) Inventor: Vinay Kumar ASTHANA, Springfield, VA (US)

(73) Assignee: Vinay Kumar Asthana, Springfield, VA (US)

(21) Appl. No.: 13/862,563

(22) Filed: Apr. 15, 2013

Related U.S. Application Data
(60) Provisional application No. 61/649,702, filed on May 21, 2012.

(51) Int. Cl. G07F 17/32

(52) U.S. Cl. CPC G07F 17/329
USPC 463/17

(57) ABSTRACT

A system and method for setting up and managing a lottery pool in a communication network. Multiple pools are managed and operated by a lottery pool manager. A lottery pool is instantiated and made available to members of the lottery pool site to participate in available open lottery pools. Any member of the lottery pool site can purchase a spot in a pool accessible to them, as long as either there are open spots to be purchased and the time of pool closing has not passed. The pool is closed when all the spots of the pool are sold or the date/time of pool closing is passed. Pool information is passed to a purchasing group, which purchases lottery tickets for the pool and posts those tickets. After the lottery pool drawing event, the winning numbers are posted. Any winnings are calculated and distributed.

### RELATED APPLICATIONS

This application claims priority to provisional patent application Ser. No. 61/649,702, filed May 21, 2012, entitled “Methods and Systems of Providing Lottery Pool Setup, Management, and Winning Distribution,” by Vinay K. Asthana, the contents of which are incorporated by reference in their entirety into this non-provisional application.

### BACKGROUND OF THE INVENTION

I. Field of Invention

The present invention relates in general to setting up, managing, and dividing the winnings of a lottery pool, offered via the interne or other type of communications network. People can become part of a lottery pool(s) by purchasing spots in a lottery pool. In more detail, the present invention relates to setup of a lottery pool, management of the lottery pool, and the cashing in the winnings and dividing the winnings of the lottery pool with the lottery pool members.

II. Background

Lottery is a game in which lottery participants pick a set of winning numbers or choose the process of lottery ticket dispensing to randomly generate the numbers for the lottery ticket(s). At the lottery drawing, a state or other jurisdiction (e.g., country, or geographic region) sponsoring the lottery devises how to pick the winning set of numbers (e.g., picking ping pong balls with different numbers on them from a revolving canister), and announces the winning set of numbers in a public manner (e.g., via a live television broadcast). A person or persons owning the ticket that matches all the winning set of numbers is awarded the lottery jackpot. If some numbers of the ticket(s) match the winning set of numbers, the person wins monetary funds as specified by the lottery agency issuing the lottery tickets. When there is no winning ticket that matches all the winning set of number for a particular lottery drawing, then the prize is said to rollover the jackpot amount to the next lottery drawing, say a lottery drawing to be conducted seven days hence, which may lead to notable increases in jackpot prize funds when there is no winning lottery ticket for several consecutive lottery drawings.

Lottery games are often offered by state governments or country governments, for example, they are sponsored by one or more states within the U.S. or country (or such as National Lottery by the United Kingdom, etc.). Lotteries come in many formats, that is, with differences in how to play and with differences in the ways to win prizes. In addition to the lottery prizes, the participation in a lottery may enable some purchasers to experience a thrill and to indulge in a fantasy of becoming wealthy. If the entertainment value (or other non-monetary value) obtained by participating in a lottery is high enough for a given individual, then the purchase of a lottery ticket could represent a gain in overall utility. In such a case, the disutility of a monetary loss could be outweighed by the combined expected utility of monetary and non-monetary gain, thus making the purchase a rational decision for that individual even if the odds of winning the lottery outweigh the expected value of winning.

Lately, many states like Illinois and Virginia, etc., have started to sell lotteries over the internet. The state of Illinois allows the residents to purchase lottery tickets online, and the state of Virginia allows a subscription model where the Virginia Lottery Subscribers can purchase the lottery tickets online. At present, U.S. state lottery sales over the internet are treated as intra-state sales, that is, only the residents of the state offering the lottery can purchase those tickets. Besides that, in order to purchase a lottery ticket, a person has to be at least a certain age, e.g., at least 18 years old.

With lottery jackpots getting to astronomical amounts, due to the jackpots getting rolled over because of no lottery winners for many consecutive lottery drawings, there is increased interest of people in ways to improve their odds of winning a huge jackpot amount. People have devised theories of how to figure out winning numbers, though they often forget that the way the game is devised, the next winning number has no bearing of the past draws (e.g., the conditional probability is zero). One way to increase the odds of winning a lottery jackpot is to join a local lottery pool with friends, family or coworkers.

In the past history of lottery winners, there have been many individual winners, that is, a single owner of the winning lottery ticket. With the way the lottery games are designed (e.g., pick six numbers with each one being a number within the range of from 1 to 49), the odds of winning the lottery can be as slim as 1 in over 100 million combination of winning numbers. In order to increase the odds of winning a jackpot, people have been collaborating with friends, family and co-workers to buy tickets jointly, by contributing funds to purchase a set of lottery tickets. Such a joint effort is also called lottery pool. There have been many instances of people winning the lottery as a pool. Joining a lottery pool is not a guarantee to win, but it does increase the odds of winning the jackpot (albeit with the proviso that the jackpot has to be shared with the other participants in the lottery pool).

A few instances of people joining, and forming lottery pools and playing the lottery and winning are described below. One instance was a lottery group called Septa 48, which consisted of four dozen Philadelphia transit agency workers that formed a pool and won a $172 million Powerball drawing. Each member had chipped in $5 for the pool, and the lottery pool bought 240 or so tickets, with one of those tickets winning the Jackpot. Another instance was a group of seven lottery pool players who won a $319 million Mega Millions Jackpot. And, there are numerous stories of people setting up lottery pools, all manually set up, all with friends, family or co-workers.

### SUMMARY OF THE INVENTION

With jackpots in multi-million dollar ranges, people like to find ways to improve the odds of hitting the jackpot. By joining a lottery pool, the members are reducing the amount of winnings that may be provided to them, as the winnings are divided among the pool members, but on the same hand, they are improving their odds of winning the jackpot many times over.

According to some embodiments, a system and method offers to setup a lottery pool for the lotteries offered in a particular area, where the jackpot is over a predetermined amount, e.g., over 100,000 dollars. Any person who is over the legal age for buying a lottery ticket, e.g., over 18 years of age, can become a registered member of the lottery pool site (for lotteries outside the U.S., the rules associated with who can purchase a lottery ticket for those lotteries will be followed). Once one has become a member, the member can participate or purchase spots in the pool, and share the winnings if that pool wins the jackpot. In order to purchase spots in the pool, a member first makes a deposit in their lottery pool site account. As part of purchasing spots in a pool, the user has to accept the terms and agreement of the pool, which specifically details how the winnings will be divided. If the pool wins any money, the money is divided among the pool members. The lottery pool winnings are handled by the team managing the pool, and are divided among the pool members, and the winning lottery pool members' respective lottery site accounts are credited with the winning share.

In some embodiments, a lottery pool site administrator will initiate the lottery pools, using information such as lottery name, date of drawing, date/time of pool closing, number of spots in the lottery pool, cost of purchasing a spot in the pool, and jackpot amount. Any member with a sufficient amount of money in their lottery pool bank account can purchase a spot or spots in one or multiple pools. When the pool reaches its capacity, that is, all the spots in the pool are taken or the date/time of pool closing is passed, the pool is closed to members to purchase a spot or spots. At that point, the purchasing group is notified about the pool closing, so that the tickets can then be purchased for the closed pool. As the tickets are purchased, the images of the tickets are scanned and made available to the lottery pool members before the drawing. After the drawing event, the results are posted online, such as on a lottery pool details web page and members of the pool are notified. If the lottery pool wins any money, it will be announced to the members of the winning lottery pool, and after deducting a pool winnings handling fees, the remainder of the winnings is divided among the members of the pool.

A lottery pool team (part of the lottery pool management) is responsible for setting up the lottery pool (public lottery pools are initiated by the lottery pool site management, and private lottery pools can be initiated by a registered member of the lottery pool site), and offer to the members the opportunity to purchase the spots in the pool, manages the pool, and handles the winnings of the lottery pool. Any person visiting the lottery site can become a registered member of the lottery pool site, provided they are over a particular age, e.g., 18 years of age, and, the person has to be a resident of the state or country offering the lottery game as per the restriction of the lottery agency offering the lottery game. A registered member with the lottery pool system can deposit money in their lottery pool web site bank account by sending money via depositing funds in lottery pool site account to credit the user account on lottery pool site, debit/credit card, money Transfer, or online payment processors like Pay Pal, etc. All processing fees are deducted from the deposit, to come up with a net amount to be invested in the lottery pool by that registered member. Any registered member can buy a spot or spots in a pool for the cost of purchasing a spot identified in the pool details. Along with the spot purchase, the member has to abide by the terms and conditions of the lottery pool, which is the agreement of joining a lottery pool, and agreement on how the lottery pool winnings are divided. Such agreement terms may be provided to each registered used as part of the terms and conditions of using the site, and at the time the user purchases spot(s) in the lottery pool(s) member must agree with those conditions in order to be able to successfully purchase spot(s) in lottery pool(s) with the lottery pool site. In any event, pool agreement terms are provided to the members at the time of purchasing a spot or spots in a pool.

The lottery pool site may offer two types of lottery pools, one called a public pool, and another called a private pool. Further, each public pool can be a fixed size (a pool with fixed number of spots in the lottery pool), or it can be an open pool with no predetermined number of maximum pool spots but rather only a minimum number of pool spots (e.g., three). Each of the pools has a close date/time, which is date/time at which a lottery pool is closed to members to purchase a spot who are seeking to purchase spot or spots into the pool. The close date/time has to be prior to the lottery game drawing, and it may be, for example, 12 hours before the actual lottery pool drawing takes place, to thereby allow time for a lottery pool web site management team member to purchase the lottery tickets for a lottery pool managed by the lottery pool web site, to scan the purchased lottery tickets and to post ticket information (image and ticket numbers) on line at least a few hours before the lottery pool drawing takes place.

Public lottery pools are pools initiated by the lottery pool team, based on the information about current lottery drawing, and other pertinent details. Public pools are accessible to any registered member, that is, any registered member can purchase spot or spots in a public pool while it is open. Public lottery pools can be initiated by the lottery pool team as fixed size pools. That is, the number of spots in the pool are fixed, or lottery pools can be initiated by the lottery pool team as open pools, with just the minimum number of spots required for the pool to be successful (for example, a lottery pool having only two members and two total tickets to be purchased by those two members may not be financially feasible to create and handle by the lottery pool team). For a fixed size lottery pool, once either all the spots are taken, a pool is closed successfully, otherwise if the pool reaches the close date/time without all spots being taken by the lottery pool members, the pool is closed, and is determined to be an incomplete pool. If there are multiple incomplete pools for the same lottery event, in some embodiments they can be consolidated to form complete pools of comparable size. For an open size public lottery pool, it is closed on the specified close date/time. If the number of spots in the open size public pool is over the minimum number of spots required to be taken, then the pool is considered to be full and it can be closed. If there are multiple open size pools that have not reached the minimum spot requirement, in some embodiments they can be consolidated to form complete pools matching or exceeding the minimum spots required.

Private pools are managed by the lottery pool team (the lottery management function), which help members who might want to setup pool with their friends, family or co-workers. Any registered member can create private lottery pool(s). The registered member setting up the private lottery pool and inviting members and prospective members by providing their information is called the pool leader. A private pool creation involves a) providing details about the private pool like lottery game, drawing date, name of the private lottery pool, and number of spots in the private lottery pool; b) providing information about the members who can participate in the lottery pool; and c) activating the private pool by purchasing spot(s) in the private lottery pool. Private pools are accessible by only the members identified in the private pool creation process. Requested members in the list are notified by the lottery pool team via an invitation to join the private pool (e.g., via an email). The pool leader is rewarded with an additional spot share, as compared to the other pool members, that is, in addition to the share of winnings for the number of spot(s) owned by the pool leader. Before the private pool is closed, the pool leader can request to add spots in the pool. The division of private lottery pool winnings, according to one or more embodiments, is detailed in paragraphs below.

As the pools are closed, the purchasing team (a part of the lottery pool management) is notified of the pool closings. The purchasing team buys the tickets for the lottery and helps the lottery pool team post the details of the purchased lottery tickets for the pool on the website prior to the lottery drawing event.

After the lottery drawing event, the winning lottery numbers are posted on a lottery pool details web page. A lottery pool team member (part of lottery pool web site management team) may use a tool (e.g., a software application) to compute the total amount of winnings of the lottery.

According to one embodiment, there is provided a lottery pool server, which includes a memory accessible by the server and configured to store information regarding at least one lottery drawing to be conducted in the future. The server also includes a processor that performs the following lottery pool management functions:

determines which users have registered to enter the at least one lottery drawing and combines respective lottery entry fees of the registered users as a collective lottery entry pool;

determines when to close an entry period for users to enter into the collective lottery entry pool;

outputs a notification for tickets to be purchased based on the combined lottery entry fees of the collective lottery entry pool provided by the users who have registered to enter the at least one lottery drawing; and

determines, after the lottery drawing has completed, whether or not the collective lottery entry pool has any winnings and if there are winnings the winnings are to be distributed to the registered users who are part of the collective lottery entry pool that won.

According to another embodiment, there is provided a computer-implemented method of creating and managing a web-based lottery pool, comprising:

storing information regarding at least one lottery drawing to be conducted in the future;

determining which users have registered to enter the at least one lottery drawing and combines respective lottery entry fees of the registered users as a collective lottery entry pool;

determining when to close an entry period for users to enter into the collective lottery entry pool;

outputs a notification for tickets to be purchased based on the combined lottery entry fees of the collective lottery entry pool provided by the users who have registered to enter the at least one lottery drawing; and

determining, after the lottery drawing has completed, whether or not the collective lottery entry pool has any winnings and if there are winnings the winnings are to be distributed to the registered users who are part of the collective lottery entry pool that won.

According to another embodiment, there is provided an apparatus comprising:

a processor including:

a first determining module configured to determine which users have registered to enter the at least one lottery drawing and combines respective lottery entry fees of the registered users as a collective lottery entry pool;

a second determining module configured to determine when to close an entry period for users to enter into the collective lottery entry pool;

a purchasing module configured to output a notification for tickets to be purchased based on the combined lottery entry fees of the collective lottery entry pool provided by the users who have registered to enter the at least one lottery drawing; and

a third determining module configured to determine, after the lottery drawing has completed, whether or not the collective lottery entry pool has any winnings and if there are winnings the winnings are to be distributed to the registered users who are part of the collective lottery entry pool that won.

### BRIEF DESCRIPTION OF THE DRAWINGS

FIG. 1 shows network communications components of an online lottery pool system according to various embodiments.

FIG. 2 shows a list of components of the lottery pool system according to various embodiments.

FIG. 3 shows the process of user login and user registration processes that are performed in the lottery pool system according to various embodiments.

FIG. 4 shows user lottery pool site bank management transactions processes that are performed in the lottery pool system according to various embodiments.

FIG. 5 shows the process of a user purchasing a spot in a lottery pool in a lottery pool system according to various embodiments.

FIG. 6 shows the process of a lottery pool instantiation, forwarding to purchasing, and lottery pool winnings handling, according to various embodiments.

FIG. 7 shows a user management process performed in the lottery pool system according to various embodiments.

FIG. 8 shows activities performed by lottery pool management process according to various embodiments.

FIG. 9 shows a process of how winnings of a lottery pool are computed according to various embodiments.

FIG. 10A shows a process of lottery pool instantiation according to various embodiments; and FIG. 10B shows details of a public pool instantiation and a private pool instantiation according to various embodiments.

FIG. 11 shows a process of closing a lottery pool according to various embodiments.

FIG. 12 shows pool manager tools for user management and notifications according to various embodiments.

FIG. 13 shows a process for depositing funds to a user's lottery pool account according to various embodiments.

FIG. 14 shows a process for withdrawing funds from a user's lottery pool account according to various embodiments.

FIG. 15 shows a process for a user to review information of their lottery pool bank account according to various embodiments.

FIG. 16 shows a lottery pool definition process according to various embodiments.

FIG. 17 is a block diagram of a computer system for which various embodiments of the invention can be implemented.

FIG. 18 is a diagram of a graphical user interface implemented as a web page for which a member can select a desired type of lottery pool, according to various embodiments.

### DETAILED DESCRIPTION

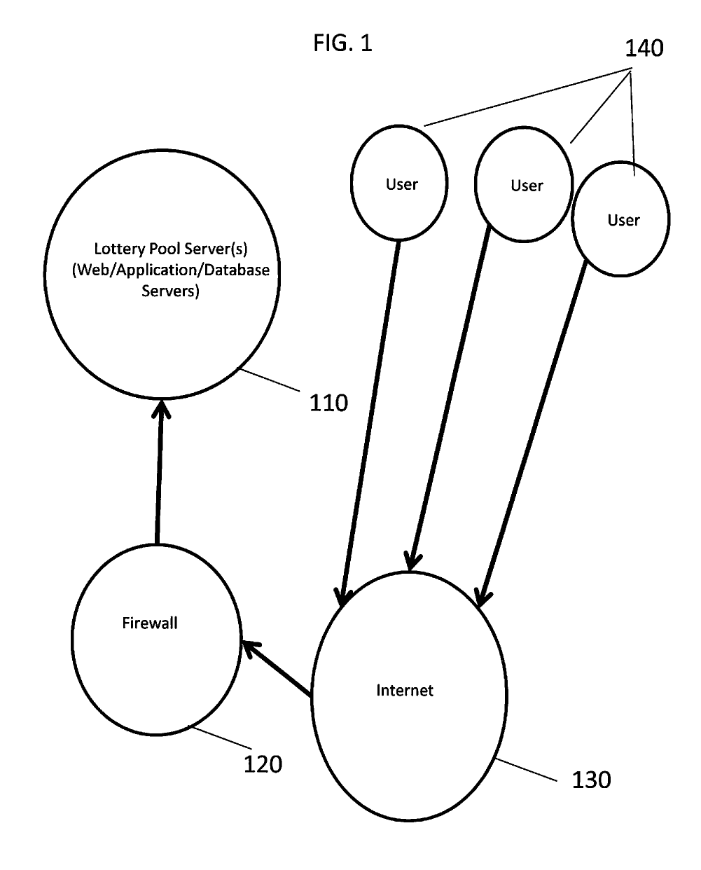

FIG. 1 shows a network communications structure for implementing a lottery pool setup, management and winning distribution system and method according to one or more embodiments. In some embodiments, the lottery pool is implemented as a software application that can be utilized by users of the world wide web (the Internet). The lottery pool system can be offered to users 140 via an internet connection 130, which then passes through a firewall 120 to one or more lottery pool servers 110 that correspond to a web-based lottery pool system. Users 140 can log in to the lottery pool website (as provided and controlled by the lottery pool servers 110) provided by the lottery pool system. Through the website, users can interact with the lottery pool via the lottery pool web application that they can download from the lottery pool servers 110 and then run on their respective computers. In more detail, a user 140 can become a registered member of the lottery pool site, deposit funds to their lottery pool bank account, withdraw funds from their lottery pool bank account, purchase spots in one or more lottery pools managed by the lottery pool site, and participate in the lottery pools available to them, all via the internet 130. The firewall 120 is provided to ensure security with respect to the personal information provided by the registered users to enter into one or more lottery pools (e.g., a user's personal information, activities at the lottery pool site etc.).

In some embodiments, the lottery pool site can utilize one or more appropriate servers to support the lottery pool web site, such as a web server, an application server, and a database server. A registered member can log into the lottery pool site using their user id and password that they created during their registration process.

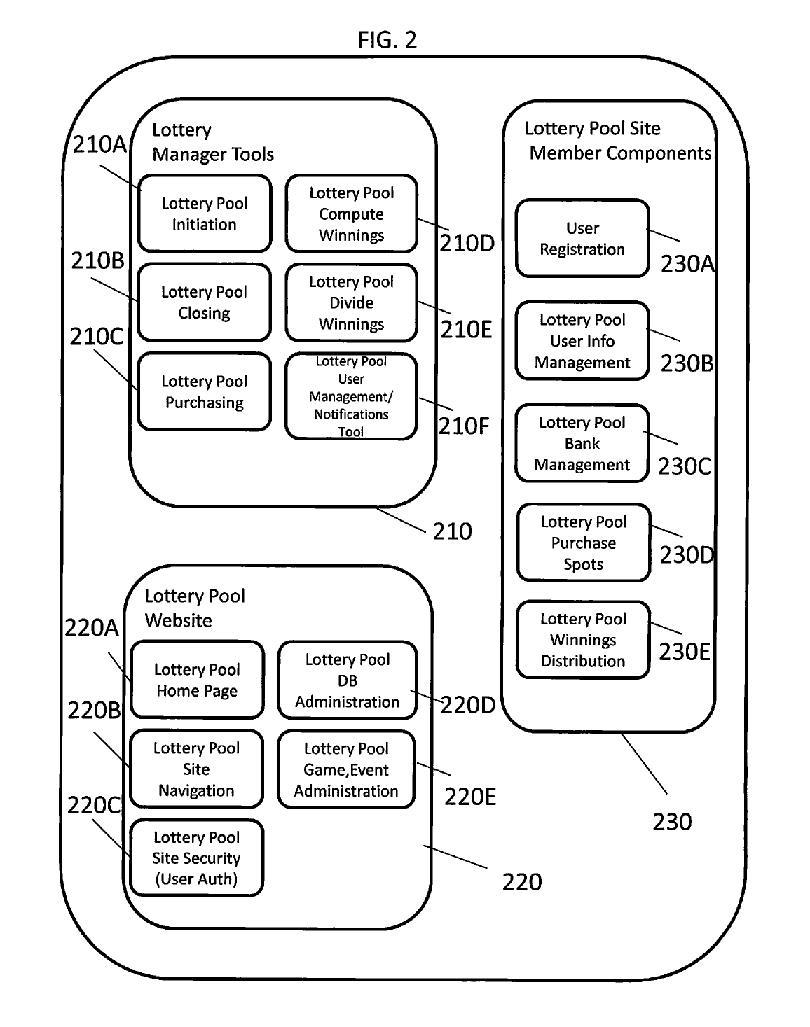

FIG. 2 shows the components making up a lottery pool application, according to some embodiments. The lottery pool application includes lottery manager tools 210 (used by lottery pool managers), lottery pool website tools 220 (to enable implementation of the lottery pool web site), and lottery pool site member tools 230 (for use by users 140 in accessing the lottery pool web site and providing information thereto). These tools may be separate software applications implemented by a computer executing computer program code stored on a computer readable medium, for example.

The lottery pool manager tools 210 for the management of the lottery pool site include: a tool 210A for instantiating a lottery pool, a tool 210B to close a lottery pool, a tool 210C, as the lottery pools are closed, to sent lottery pool information to purchasing group, a tool 210D to compute the winnings of the pool, a tool 210E to divide the winnings of the pool with members of the pool, and a tool 210F used by other tools to notify those other tools of pertinent information regarding the lottery pool and/or the lottery drawing.

The lottery pool website management tools 220 include: a tool 220A for displaying the home page for the website, a tool 220B for providing ways for the users to navigate the contents of the lottery pool web site, a tool 220C for authenticating a registered user, a tool 220D for managing the database for the lottery pool components, and a tool 220E for managing the lottery pool game and events. Lottery pool games are the lottery games available in the geographical area (e.g., State or Country). Lottery pool events may correspond, for example, to the lottery drawings For example, Power Ball drawing for Mar. 15, 2013. The lottery pool management team can enter and review the information about the drawing events and the results of the drawing events in the system via the lottery pool event administration tool 220E.

The lottery pool member tools 230 utilized by users of the lottery pool site include: a tool 230A to register a user, a tool 230B to manage the user information, a tool 230C to manage the lottery pool bank account for a registered user (“lottery pool bank management”), a tool 230D to help purchase spots in the lottery pool, and a tool 230E to calculate and distribute the winnings of the lottery pool. These tools are provided to assist a user of the lottery pool web site to do various tasks at the lottery pool web site in a convenient and easy-to-understand manner.

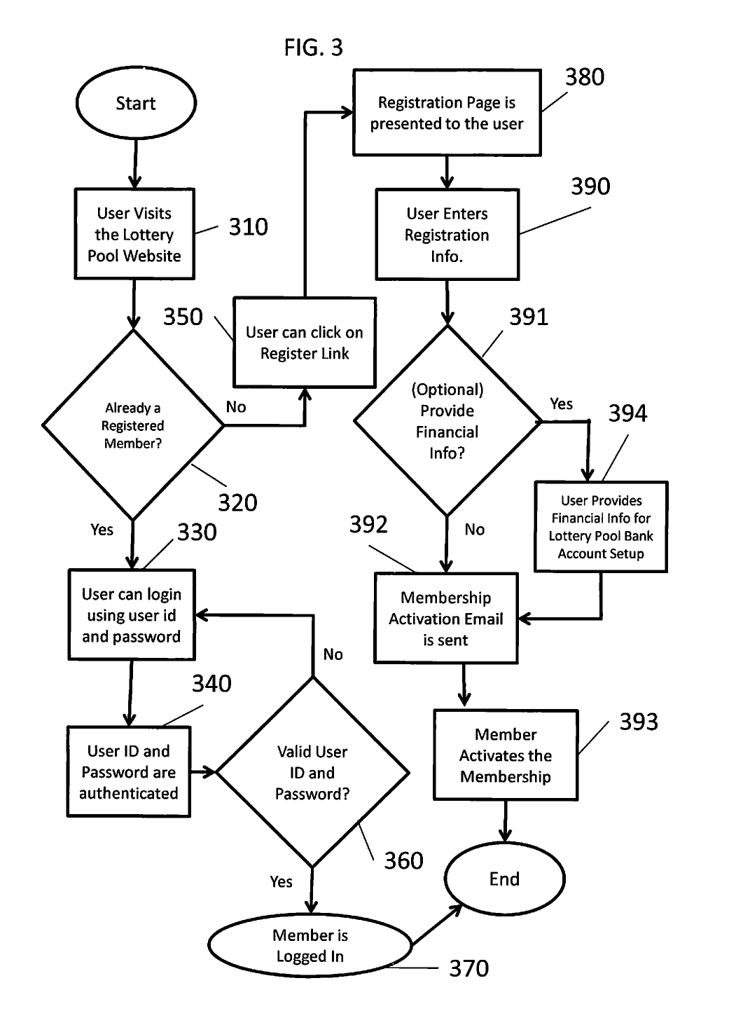

FIG. 3 is a flow diagram showing steps involved in a lottery pool site user login and registration process, according to some embodiments. The user login or registration process allows a user to be authenticated and allows the user to perform various tasks, as a registered member of the lottery pool web site. In order for a user to be able to login, he/she first registers with the lottery pool website. The criteria for a member to join a lottery pool is, a) they have to be over a certain age, e.g., over 18 years of age, and b) they should be a resident of the jurisdiction that has created the particular lottery that the user is seeking to enter into a lottery pool (e.g., a U.S. state if the user is seeking to join a lottery pool in the U.S.).

In block 310, a user visits the lottery pool website. A user can access the lottery pool website using the Uniform Resource Locator (URL) for the website that has been made available to them (e.g., found after doing a web search for lottery pool websites). On the home page of the website, the user will be able to see the list of drawing events coming up in the near future, a list of lottery pools going on for which the user can seek to join, and a link to register or to login for an existing registered member of the lottery pool website.

In block 320, it is determined if a user wishes to become a registered member of the lottery pool website. If the user is already a registered member of the lottery pool website, they can login in block 330. If the user is not an existing registered member of the lottery pool website, they can register to become a registered member of the lottery pool site in block 350.

In block 330, in order to login, a user can provide their user id, which can be their email address, and a password they have selected at the time of registration at the lottery pool website.

In block 340, the user id and password provided by the user is authenticated against the database entries for the user as stored by the lottery pool web site (e.g., stored in a memory accessible by the lottery pool website).

In block 360, if the member is found in the database, and the user ID and password match with information of that member in the database, the user is authenticated, and in block 370 the user is logged into the lottery pool website. If the user is not validated, that is, their user id and passwords do not match with information stored in the database in block 360, the user is sent back to block 330 to provide the user id and password again.

In block 350, if a user selects to register themselves on the lottery pool website, the user is presented with an online form to register himself/herself to the lottery pool website.

In block 380, which shows part of the registration process, the registration page asks the user for their personal identifiable information, a user id of choice, allows the user to select a password for their user id and optionally a security question.

In block 390, the user can enter his/her personal information, and optionally is asked to provide his/her financial information such as bank or credit card information the user wishes to use at the lottery pool website.

In block 391, the user is asked to provide his/her financial information at the time of registration, which is optional. If the user selects not to provide the financial information, the user can skip over the financial information section in the registration process, and a membership activation email is sent to the user in block 392 after completing the registration process. If the user wishes to enter the financial information, then in block 394 the user is sent to a web page where he/she can enter the financial information.

As stated above, in block 392, after the user completes the registration information, the system generates a authentication email and sends it to the email address provided by the user. In some embodiments, the email may contain a link to authenticate the email and activate the user lottery pool account.

In block 393, as the user opens the email sent from lottery pool website, that is, when the user opens the user activation link in the email, the user information is matched—user id, user email address and activation code—and the user is activated. Once the user is activated, the user is now ready to use their lottery pool account.

In block 394, optionally if the user wishes to provide their financial information during the registration process, the user can provide information such as his/her bank account information for depositing or withdrawing funds from the lottery pool website. Additionally, a user can specify alternate ways, depositing funds in the lottery pool site account to credit the user account on the site, credit card information to be used for paying for the lottery pool spot purchases, or personal bank account information to be used for paying for the lottery pool spot purchases, in order to fund the user's lottery pool bank account.

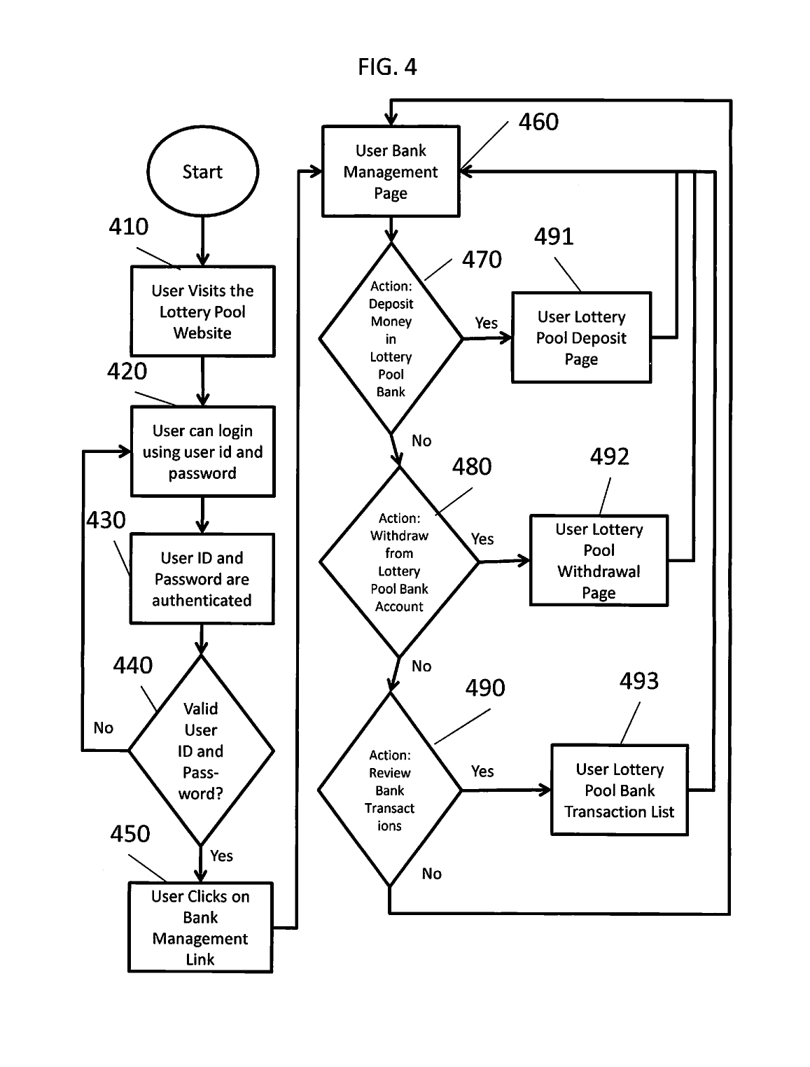

FIG. 4 is a flow diagram showing lottery pool website and user bank transactions according to some embodiments. The lottery pool website manages a user lottery pool bank account, which is funded by the user using various deposit options. The lottery pool website withdraws funds from the user's lottery pool bank account based on requests by the user to enter into one or more pools. The lottery pool website also allows viewing of the transactions done thru the lottery pool bank account for the registered user.

In order for a user to be able to manage their lottery pool bank account, the user has to be a registered member of the lottery pool site, with a user id and a password. Any registered user has to login to the lottery pool site using their user id and password for the lottery pool web site. In block 410, the user visits the lottery pool website. In block 420, the user logs in to the lottery pool web site using the user's user ID and password. In block 430, the user's user ID and password entered in block 420 are authenticated. If the authentication is not successful, the user is sent back to block 420 to reenter his/her user ID and password, for a subsequent authentication of the user. If the authentication is successful, the user is allowed entry into their personal account in the lottery pool website.

In block 450, once logged in to the lottery pool website using a matching user id and password, the user is given the option to perform various tasks. One of the actions available to the user is to manage their lottery pool website bank account. The user may do this by clicking on a bank management link on their lottery pool website personal information web page, which will take the user to a web page that allows the user to modify any bank account and/or credit card information that the user had previously entered, or for the user to delete existing bank account/credit card information or add new bank account/credit card information.

As the user selects to manage their bank account in block 450, in block 460 the user is presented with the web page to manage their lottery pool bank account. The user has various actions available to them on the manage bank account web page. Some of the core actions available to the user may include: a) deposit funds to their lottery pool bank account, b) withdraw funds from their lottery pool bank account, and c) review bank transactions, to enable the user to review the list of transaction thru their lottery pool bank account.

In block 470, if the user selects the option to deposit funds to their lottery pool bank account, then in block 491 the user is presented with a web page to provide instructions and enable the user to deposit funds to their lottery pool bank account. If the user does not select any of the actions on the user bank management web page, the control stays on the user bank management web page (to await an action from the user).

In block 480, if the user selects the option to withdraw funds from their lottery pool bank account, then in block 492 the user is presented with a web page to withdraw funds from their lottery pool bank account. If the user does not select any of the actions on the user bank management web page, the control stays on the user bank management web page (to await an action from the user).

In block 490, if the user selects the option to review bank transactions, then in block 493 the user is presented a page with a list of his/her bank transactions thru their lottery pool bank account. Once the user has finished any of blocks 491, 492 or 493, the user is sent back to the user bank management web page (in block 460), to perform any other bank management that the user desires to do.

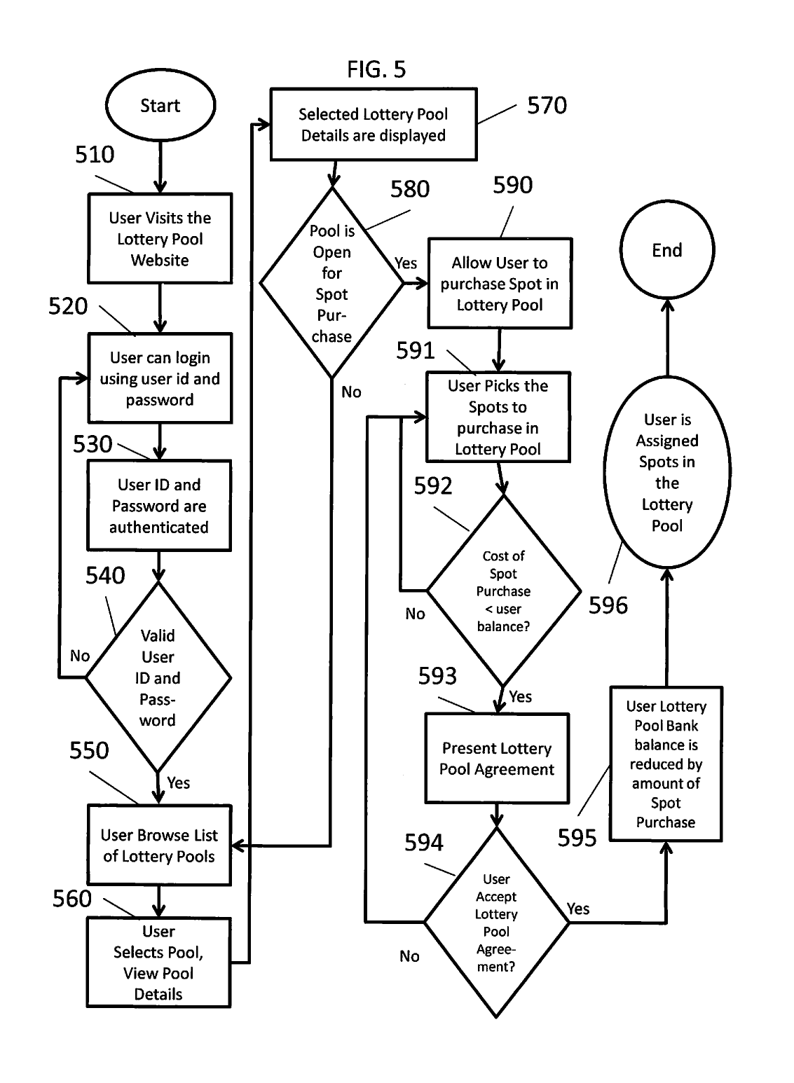

FIG. 5 is a flow diagram showing the tasks involved in a user purchasing a spot or spots in a lottery pool managed by a lottery pool website, according to some embodiments. In these embodiments, any registered user can purchase a spot in an open lottery pool that is accessible to them.

Only a registered user of the lottery pool website is allowed to purchase spots in a lottery pool managed by the website. In block 510, a user visits the lottery pool website. In block 520, the user can log into their account using the user id and password specified at the time of user registration. In block 530, the user id and password are authenticated against an authentication database containing the user registration information, which is accessible by the lottery pool website. In block 540, if the user ID and password are valid, the user is provided to their personal webpage on the website (block 550), and if the user ID and password are not valid, the user is sent back to block 520 to reenter their user ID and password for a subsequent authentication attempt by the user.

In block 550, as the user is logged into the website, the user can browse a list of lottery pools currently running, with indications as to which ones are open for the user to purchase a spot in a lottery pool. The user can select any listed pool to view the details about the lottery pool.

In block 560, if the user selects a pool from the list of available pools on the web site, in block 570 the pool is presented in the web page with details of the selected lottery pool. Details of a lottery pool may include, name of pool, closing date/time of the pool, and type of pool (Public/Private). Additional classification of a public pool is that it can be fixed size, or open size pool, the total number of spots in the pool (in case of a fixed size pool), the number of open spots in the lottery pool, the cost of purchasing a spot in the pool, and the drawing event details (lottery drawing identifier, date/time of drawing).

In block 580, if the selected pool has spots open for the user to purchase, then in block 590 the user is allowed to purchase spots in the lottery pool. Additional criteria may be, for example, if the pool is private, then the user has to be an invited member to join the lottery pool and purchase spots in the private pool. One criterion for a user to purchase spots in the pool is the total cost of the spots that the user wishes to be buying should be less than the amount in user's lottery pool bank account. In alternative implementations, the user may be provided with a loan from the lottery pool website, which the user has to replenish within some fixed time period (e.g., within one week from the date of purchase of a spot in the pool). The loan amount may be assigned a particular interest rate (e.g., a value between 20% and 50%) in order to incentivize the user to pay the loan off quickly to the lottery pool website. If in block 580 the selected pool does not have spots open for the user to purchase, then the user is sent back to block 550 to view other available pools for possibly purchasing a spot in.

In block 591, after having been allowed to purchase a spot in the selected lottery pool, the user can pick one or more spots to purchase in the lottery pool that is available to the user to purchase spots in the lottery pool.

In block 592, once the user selects the number of spots the user wishes to purchase, the number of spots is multiplied with the cost of purchase of each spot, and the total purchase price is compared with the balance of funds in the user's lottery pool bank account.

If the balance of funds is greater than the amount needed to purchase the spot or spots, the purchase is successful, and in block 593 the user is presented with the lottery pool agreement for that particular lottery pool. Each user has to accept the lottery pool agreement in order to join a lottery pool. The lottery pool agreement lists the rules and regulations of the lottery pool, and also lists the rules for dividing the lottery pool winnings. In order for the user to join the pool, the user has to agree to the terms and conditions of the lottery pool as set forth in the agreement.

In block, 594, the user is presented the option to accept or decline the lottery pool agreement. If the user agrees to the lottery pool agreement, the purchase of spots process continues. If the user declines the agreement, the user is sent back to block 591, which is the initial purchase process step to select the number of spots they wish to purchase in a different lottery pool.

Once the user agrees to the lottery pool agreement, then in block 595 the cost of the spot purchased is deducted from the users lottery pool bank account.

The last block 596 in the lottery pool spot purchase process shown in FIG. 5 is the notification to the user of the lottery pool spots they have purchased. This notification can be done via a confirmation email sent to the user from the lottery pool web site.

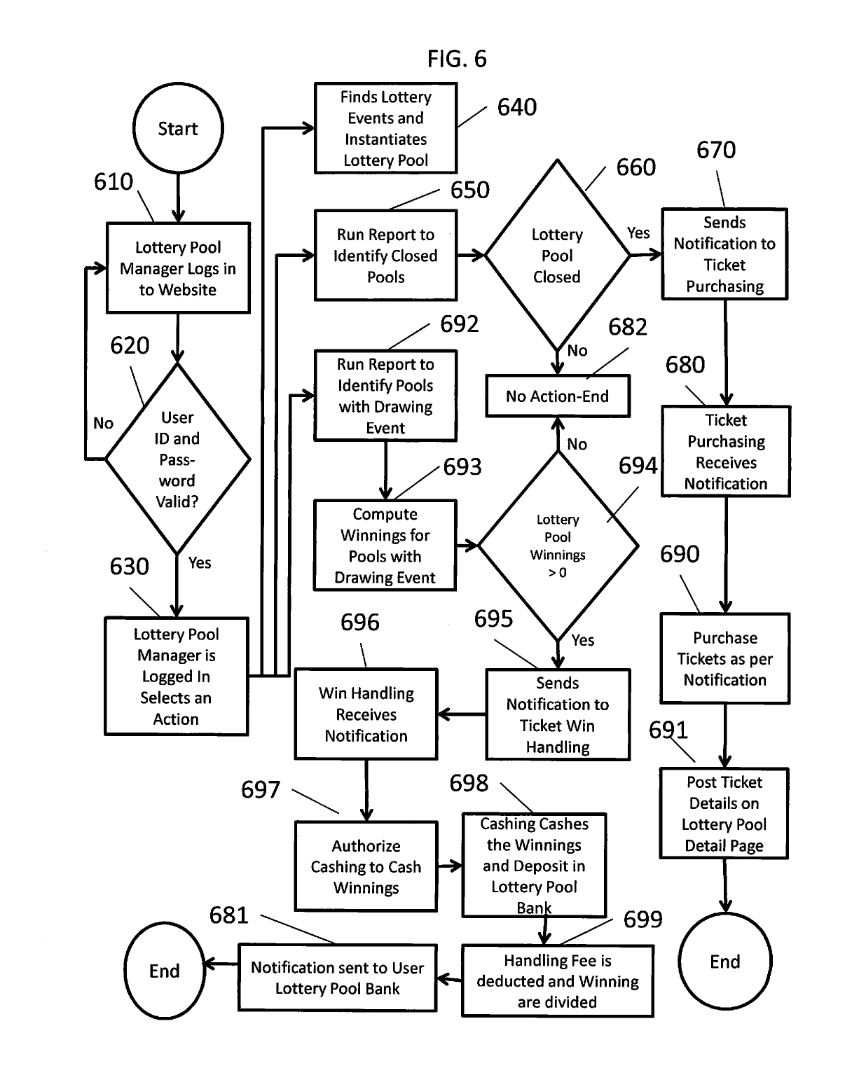

FIG. 6 is a flow diagram showing tasks performed in lottery pool management, lottery pool instantiation, pool purchasing notification procedures, and lottery pool winnings handling, according to some embodiments. Public lottery pools are instantiated by a member of the lottery pool management team, who is provided with sufficient access rights on the lottery pool website.

In block 610, in order to perform lottery pool management activities, a management team member logs in to the web site using their user id and password.

In block 620, the user id and password entered by the lottery pool management team member are authenticated against the lottery pool authentication database.

In block 630, if the user id and password of the management team member are authenticated against the database, and matched, then the management team member is logged on to the lottery pool web site, and has rights to instantiate (e.g., create) a lottery pool having spots available for purchase on the web site.

As a lottery pool management team member, the member can access the future drawing events. That is, the management team member can access lottery game drawings, and their associated details such as date/time of drawing, game, and jackpot amount. Using the future drawing event information, in block 640, the member can instantiate new lottery pools, and make them available to the users of the site to join the pools by purchasing spots in the pool. A private lottery pool can be instantiated by a registered member of the lottery pool site.

Another responsibility of a lottery pool management team member is to process the closed pools. Pools are closed automatically as either all the spots in the pool are taken, or they passed the lottery pool closing date/time. In some embodiments, the management team member can run a utility function to obtain a report that identifies the list of pools that are closed in block 650. If the lottery pool is not closed, as determined in block 660, then no action is taken for that lottery pool, as shown in block 682.

As the lottery pools are closed, if the closing is due to exhaustion of the spots in the lottery pool, in block 670 a notification is sent to the purchase group of the lottery pool closing. In case there are spots left in the pool and the lottery pool is closed due to the expiry of pool closing date/time, in some embodiments those pools are consolidated if possible with other pools which are comparable in size, same drawing event and where there is room to consolidate, and the user is notified of the consolidation.

In block 680, a ticket purchasing management team member receives the notification output in block 670, and in block 690 that person goes out and purchases the number of tickets for the drawing event, using the funds from the lottery pool.

After the tickets have been purchased, all the tickets for the lottery pool are scanned and ticket number information is entered in the system in block 691, and that information is made available to the members of the lottery pool for viewing on the lottery pool web site.

As shown in block 692, the lottery pool management team member can also run a report to identify the pools that have drawing events, that their target lottery was played, and that the results are available.

For the lottery drawing events, in block 693 the results are identified, and a tool is initiated to compute if the lottery pool won any money. This component can be alternatively triggered by the posting of the lottery game results.

In block 694, a determination is made as to whether the combined winnings of all the tickets in the lottery pool is over $0, and if so, in block 695, a notification (e.g., email) is sent to a Win Handling division of the lottery management team, for allocation of those winnings to the members of the winning lottery team.

As shown in block 696, the win handling division receives a notification that a lottery pool winnings are over $0, and the win handling division authorizes a cash winnings ticket division of the lottery pool management team to cash the winning tickets from the lottery pool.

As shown in block 697, the cash winnings ticket division is authorized to cash the winning tickets, in which they identify the batch of tickets for the lottery pool and cash the winning tickets.

As shown in block 698, a cash winnings ticket division team member takes the winning tickets to a retailer, or to the lottery agency (for a large winning ticket amount), and cashes the winnings.

Out of the winnings from the lottery pool, in block 699 a predetermined amount of the winnings is deducted as win handling fees, and is assigned to the lottery pool management. For example, the deduction may be a fixed amount for any sized lottery pool, e.g., $50 to $75, or it may a percentage of the winnings amount (e.g., 5% of the winnings amount).

In block 681, a notification is sent to lottery pool members of the lottery pool that they joined won money, and whereby the notification also includes their winning share computation, in which their winning share is deposited into their lottery pool bank account. The notification can be made via an email, for example.

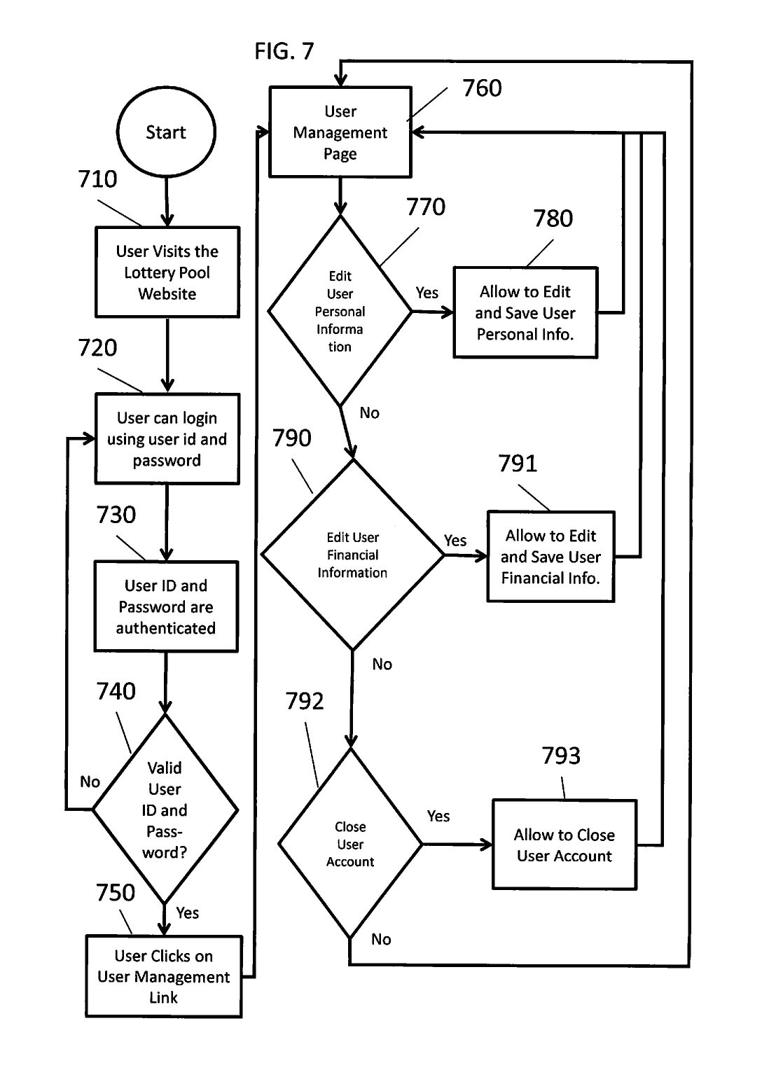

FIG. 7 is a flow diagram showing tasks involved with respect to lottery pool user interaction with a lottery pool website, as well as tasks involved with respect to user management of the lottery pool website, according to some embodiments. Any registered user of the lottery pool site is allowed to manage that user's information on the website, such as: a) personal information, b) financial information, or c) to the user's desire to close their user account.

In order for a registered user to manage the user's information, the user visits the lottery pool website in block 710, and then the user logs on to the lottery pool site using their user id and password in block 720. In block 730, the user id and password entered by the user is authenticated against the database of the lottery pool website that holds the user registration information.

If the user is authenticated in block 740, the user can select an action to manage their user account in block 750. If the user is not authenticated in block 740, the user is sent back to block 720, to reenter user authentication information to reattempt to get authorized by the lottery pool website.

As shown in block 760, as the user selects the action to perform user information management, a web page is displayed with actions available, such as a) manage personal information, b) manage financial information, or c) close user account.

If the user selects the action to update the user personal information in block 770, the user is presented with a page with the user's personal information, and the user is allowed to edit and save the personal information in block 780. Personal information can include such information as residence address, and other contact information.

If the user selects the action to update the user financial information in block 790, the user is presented with a page with the user's financial information, and the user is allowed to edit and save the financial information in block 791. Financial information may include bank account information associated to the user account, credit card information associated with the user account, or any other online pay engine associated with the user account.

Also, a user has the option to close their user account from the user information management page in block 792, in which any user can close their lottery pool account. The user is then prompted in block 793 to confirm if they wish to close their user account. Once the user confirms their wish to close their user account from the lottery pool website, their user id is disabled from any future actions. If the user does not pick any of the options of user management page, the control stays on the user management page, and returns back to block 760 to allow further actions by the user on that page.

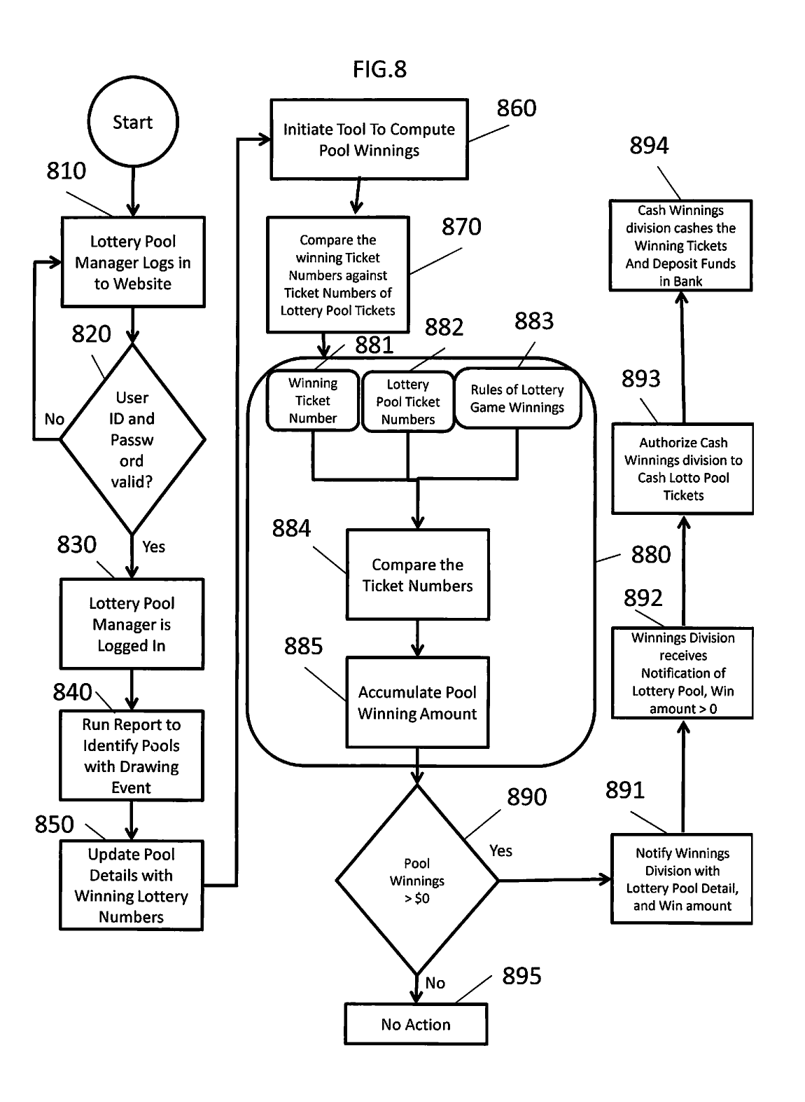

FIG. 8 is a flow diagram showing tasks performed by a lottery pool tool (e.g., a software application executed by a computer) used by the lottery pool management team to compute winnings of a lottery pool, according to some embodiments.

A lottery pool management team member logs into the lottery pool site using his/her user id and password in block 810. The user id and password are matched against the database holding valid user ids and passwords of the lottery pool management team members in block 820. If the member is an active team member of the lottery pool site, the member is logged in to the site in block 830 and given access to utility functions allowed for lottery pool management team members. If the user is not validated as a lottery pool management team member, the user is returned to block 810 to reattempt the validation.

Once logged in, in block 840 the lottery pool management team member can run a utility application to identify all the lottery pools with drawing event, that is, all the closed lottery pools that had a drawing event.

In block 850, the lottery pool management team member can find out the winning information for the lottery, and update the details of the lottery pool with the winning information.

In block 860, a tool is initiated to compute the winnings of the lottery pool that is used to compare the ticket information with the winning information. The tool to compute winnings can be initiated alternatively by posting the results of a lottery game.

The winning information for the lottery drawing event is compared with the lottery ticket information in block 870, which is part of the current pool. The details of how the winnings are computed are detailed in block 881-885 described below.

The winnings of the lottery pool are computed using the information such as: Winning ticket number 881, Lottery pool ticket numbers 882, and the rules of the lottery winnings 883 (i.e., amount of winnings for matching conditions such as three matching numbers result in winning of $1000, etc.). In block 884, the lottery pool tickets are compared against the winning ticket numbers, and based on the matching numbers, and the rules of lottery winnings, the total winnings of all the tickets in the pool is accumulated in block 885.

If the pool winnings are greater than $0, as determined in block 890, there is a winning division (blocks 891 and so on), otherwise in block 895 there is no further action for the lottery pool.

As mentioned above, in block 891 a winnings handling division of the lottery pool management team is notified of the lottery pool and winnings if the accumulated winnings of the pool are over $0.

In block 892, the winnings handling division receives the notification, identifies the lottery pool, and in block 893 a cashing division of the lottery pool management team is authorized to cash the lottery tickets.

In block 894, a member of the cashing division cashes the lottery tickets (e.g., at a retailer or at the lottery agency itself if the winnings amount is very large), and deposits the funds in the lottery pool bank account.

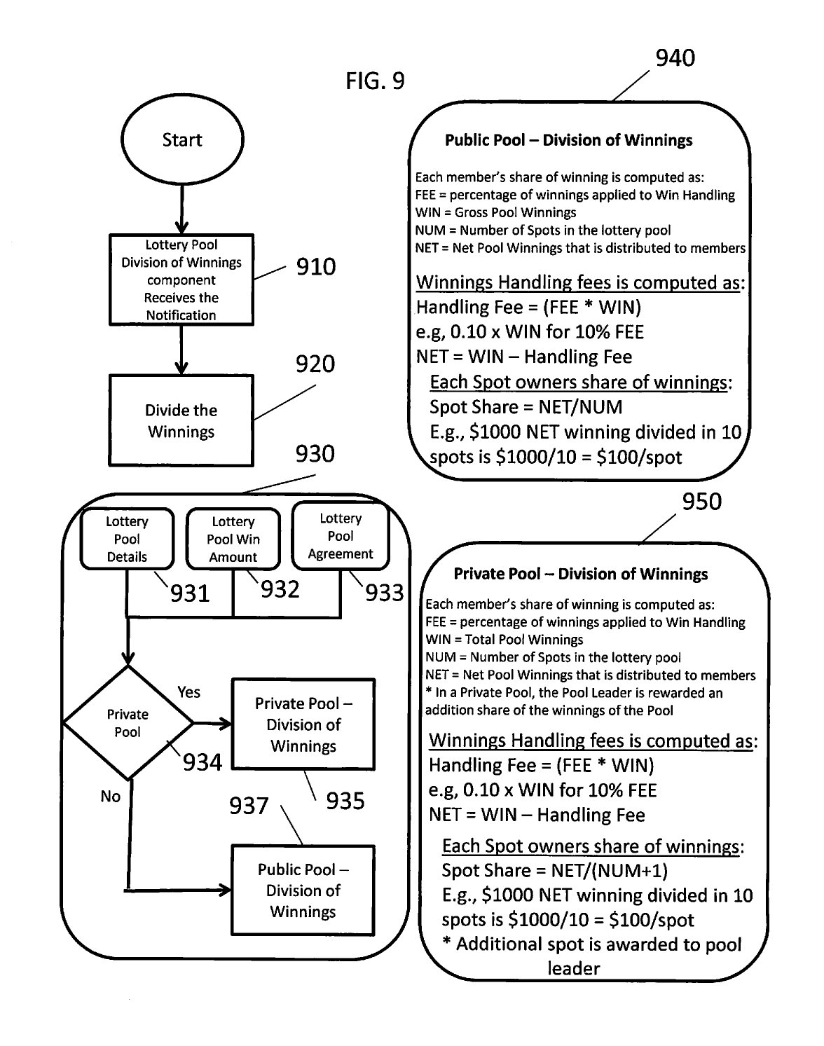

FIG. 9 is a flow diagram showing tasks performed by a lottery pool tool utilized by a lottery pool management team member to divide the winnings among the members of a winning lottery pool, according to some embodiments. FIG. 9 also shows details of the public pool division of winnings and the private pool division of winnings. A percentage amount of winning handling fee is added, and in order to deduct the winning handling fees, it is added to the division of the lottery pool winnings. That is, for example, for a 100 spot pool, with 10% of winning handling fees, the Net winnings of the lottery pool is calculated by subtracting the Handling fee from the Gross winnings. The share of winnings for each spot is calculated by dividing the Net winnings into number of spots in the lottery pool that won.

In block 910, the divide winnings tool to compute winning is initiated by a notification that the lottery pool has a winning over $0 (see block 810 in FIG. 8, for example).

In block 920, the lottery pool winnings are divided as explained below in the following figure descriptions for blocks 930, 940 and 950.

Block 930 shows that the lottery pools are divided into two categories: public pools and private pools. To compute the winning shares of the spot owners of the winning lottery pool, lottery pool details 931, winning amount 932, and information from the lottery pool 933 are used. The lottery pool agreement shows the percentage for the lottery winning handling fee. Based on the lottery pool details 931, winning amount 932, and information from the lottery pool agreement 933, a determination is made in block 934 as to whether the lottery pool is a private pool. If Yes, then the private pool division of winnings formulas are used to divide the winnings, as provided in block 935. If No, then the lottery pool is a public pool (by default, since a pool can either be a private pool or a public pool), and then the public pool division of winnings formulas are used to divide the winnings, as provided in block 937.

In case of a public lottery pool, block 940 lists formulas for computing public lottery pool winnings can be used in some embodiments.

In case of a private lottery pool, block 950 lists formulas for computing private pool winnings can be used in some embodiments.

As shown in block 940, for a public pool division of winnings amount, information used for the public pool winnings can include: FEE: percentage of fees from the lottery pool winnings given to the lotto pool management team, WIN: gross dollar amount of the accumulated dollar amount of the lottery pool, NET: Net amount of winnings that is distributed in the spot owners,

and NUM: Number of spots in the pool. NET Distributable Winning=WIN−WIN*FEE, where WIN=Gross Winnings of the lottery pool.

Public pool lottery pool spot owners share of the winning can be calculated as:

Winnings from the lottery pool=GROSS

Number of spot(s) in the lottery pool (that won)=NUM

Fee percentage for Win Handling=FEE (e.g., 10%)

NET=Net distributable winning from the lottery pool

NET=GROSS−(GROSS*FEE)

Each spot share of winnings=NET/NUM

The FEE number of spots share goes towards the payment of the win handling fee. The FEE, percentage of winnings applied to win handling, is specified at lottery pool instantiation, and is part of the lottery pool agreement in some embodiments.

Block 950 shows a private pool division of winnings, in which private pools are instantiated based on the request from lottery pool user. The lottery pool user requesting the private lottery pool is rewarded by receiving an additional spot share from the lottery pool winnings. Information used for the private pool winnings can include: FEE: percentage of fees from the lottery pool winnings given to the lottery pool management team, WIN: gross dollar amount of the accumulated dollar amount of the lottery pool, and NUM: Number of spots in the pool. NET Distributable Winning=WIN−(WIN*FEE), where WIN=Gross Winnings of the lottery pool.

Each spot share of the winnings of the private Lottery Pool (pool leader receives an additional spot share) receives. The winning share of a spot in the private lottery pool can be calculated as:

Winnings from the lottery pool=GROSS

Number of spot(s) in the lottery pool (that won)=NUM

Fee percentage for Win Handling=FEE (e.g., 10%)

NET=Net distributable winning from the lottery pool

NET=GROSS−(GROSS*FEE)

Each spot share of winnings=NET/(NUM+1)

The pool leader (i.e., the user who requested that the private pool be created) receives, in addition to his/her share of spots he/she owns, an addition spot payment for being the pool leader.

The FEE*GROSS (gross amount of winning) goes towards the payment of the win handling fee. This fee is awarded to the lottery pool site management.

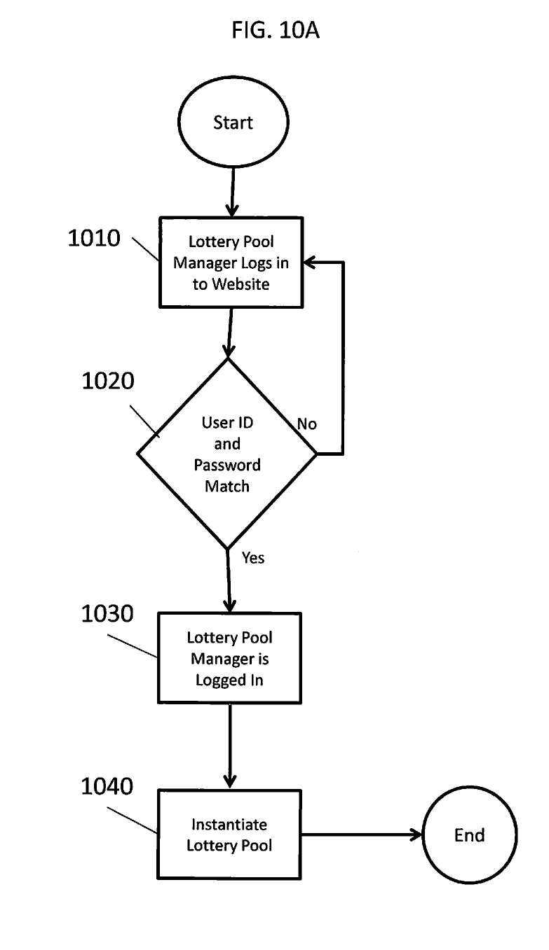

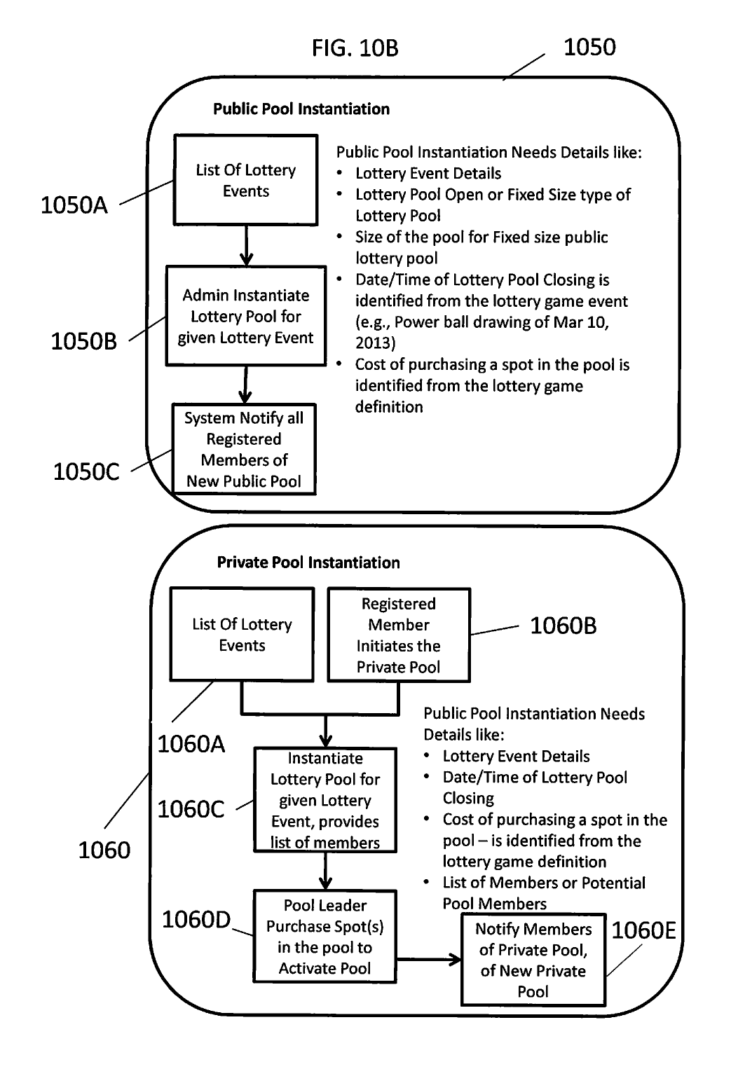

FIG. 10A is a flow diagram showing tasks performed by a lottery pool tool used by the lottery pool management team to instantiate a lottery pool according to some embodiments, and FIG. 10B shows details of a public pool instantiation and a private pool instantiation.

In order to instantiate a lottery pool, a lottery pool management team member logs into the lottery pool web site with their user id and password in block 1010. The management team member's user id and password are validated against an authentication database in step 1020 to confirm the person logging in is an active member of the management team. If the member is not authenticated, then the user is sent back to block 1010 to reattempt an authentication as a lottery pool management team member.

Once the management team member is logged in to the lottery pool site as a lottery pool management team member in block 1030, that member can select to instantiate a lottery pool in block 1040.

The following paragraphs describe the Public Lottery Pool Instantiation and Private Pool Instantiation performed in block 1040, as detailed in FIG. 10B.

A lottery pool can be a public pool, in which any member of the lottery pool site has access to purchasing a spot in the pool. In that case, as shown in block 1050, the lottery pool management team member uses lottery drawing event information to obtain a list of lottery events in block 1050A, and instantiate a public pool, as shown in block 1050B. Once the pool is instantiated in block 1050B, a notification is sent to all the members of the lottery pool site in block 1050C, inviting them to purchase spots in the public pool.

A lottery pool can alternatively be a private pool, in which only the member specified in the request for creation or added by the pool leader can purchase the spots in the pool. As shown in block 1060, any registered member of the lottery pool site can use lottery drawing event information in block 1060A and the request to set up a private pool in block 1060B for setting up private lottery pools. As the private lottery pool is setup and instantiated in block 1060C, the pool leader purchases spots in the pool to activate the pool in block 1060D, and all the members specified in the private pool request are sent notifications in block 1060E, inviting them to purchase spots in the pool. In some embodiments, a member can set up a private pool entirely by himself/herself by using a lottery pool software application, without requiring the assistance from a lottery pool management team member.

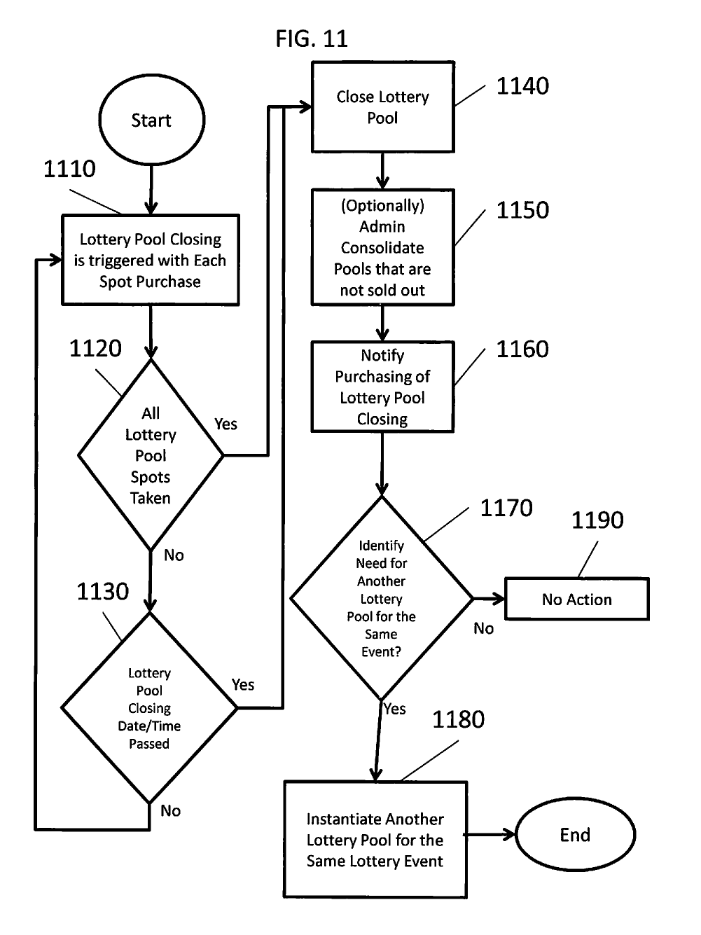

FIG. 11 is a flow diagram showing a lottery tool used to perform lottery tool closing by the lottery pool management team, according to some embodiments.

In block 1110, a lottery pool closing is triggered with each spot purchased in a lottery pool, in which a check is performed with each purchase of the spots in the pool.

With each successful purchase of the spots in the lottery pool, in block 1120 it is checked if all the spots in the pool are taken. If all the spots are taken, a lottery pool is closed in block 1140, as there are no more spots available in the lottery pool to purchase by other registered users of the site.

Lottery pools are also closed if the closing date/time of the lottery pool is passed, as shown in block 1130. If the lottery pools date/time of pool closing specified in the pool instantiation is passed, a pool is closed in block 1140 and no registered user can purchase spots in the closed pool.

In block 1160, a pool purchasing division of the lottery pool management team is notified of the pool closing (e.g., via email), so they can process the lottery pool closing. If the pool is not sold out, a determination is made in block 1150 as to whether it can be consolidated with other pools which are not completely sold out, and the spot owners are notified of the lottery pool closing.

The lottery pool management team is notified of the pool closing in block 1160, and at that point they can decide if there is enough time and interest in another pool for the same drawing event in block 1170, and if so additional pools for the same drawing event are instantiated in block 1180. If the lottery pool management team decides against creation of any new lottery pools for the same lottery drawing even, no action is taken in block 1190. The determination as to whether or not to instantiate a new pool after a pool has closed can be made based on the rate at which spots were being purchased in the just-closed pool, whereby if the rate is greater than a predetermined amount, e.g., two or more spots purchased per hour, and the amount of time until the pool is to be closed due to the lottery drawing happening soon thereafter, those parameters can be used to open up a new pool for registered users to join. Thus, if X*Y>Z, where X is the rate at which spots are being purchased in a just-closed pool (e.g., 2 per hour), and Y is the amount of time (in hours) remaining until the pools for that lottery drawing are to close, e.g., 15 hours, and Z is some fixed value (e.g., 20), a lottery pool can be automatically instantiated for potential purchase of spots by users of the lottery pool web site.

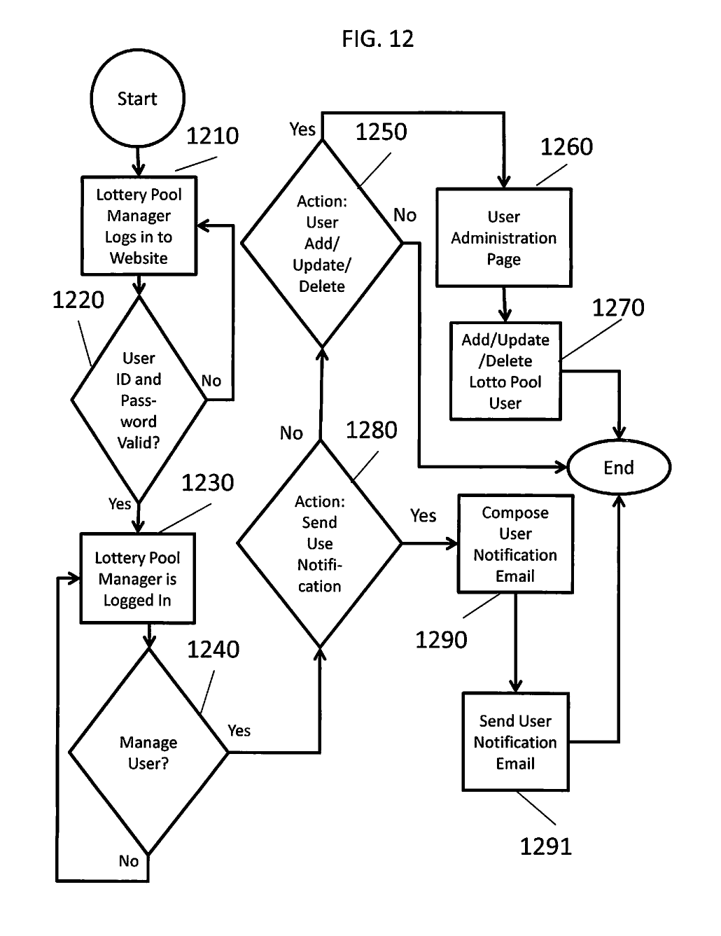

FIG. 12 is a flow diagram showing steps performed by a lottery pool management tool for user management and for sending notifications to registered users, according to some embodiments.

In order for a lottery pool management team member to use the lottery pool management tool for user management and user notification, they have to log into the lottery pool site using their user id and password, as shown in block 1210. The entered user id and password are authenticated in block 1220. If the authentication is successful, the user is logged onto the lottery pool web site as a lottery pool management team member in block 1230, and if the authentication is not successful, the user is sent back to block 1210 to reattempt authentication. Once authenticated, the member can determine in block 1240 whether to manage registered users in the lottery pool website.

If the lottery pool management team member wishes to send a notification to a registered user in block 1280, that person can utilize this tool to compose a notification email in block 1290, identify a user and send the notification to that user in block 1291. Alternatively the management member can add/update/delete a user as performed in block 1270.

If the lottery pool management team member does not want to send a notification to a registered user, then the tool proceeds to block 1250, to determine if the lottery pool management team member wishes to add/update/delete a user using this tool. If Yes, the lottery pool management team member is presented with a user administration web page in block 1260. The user administration web page allows the lottery pool management team member to add/update/delete a user, as performed in block 1270. If the lottery pool management team member does not want to add/update/delete a user, then the process ends.

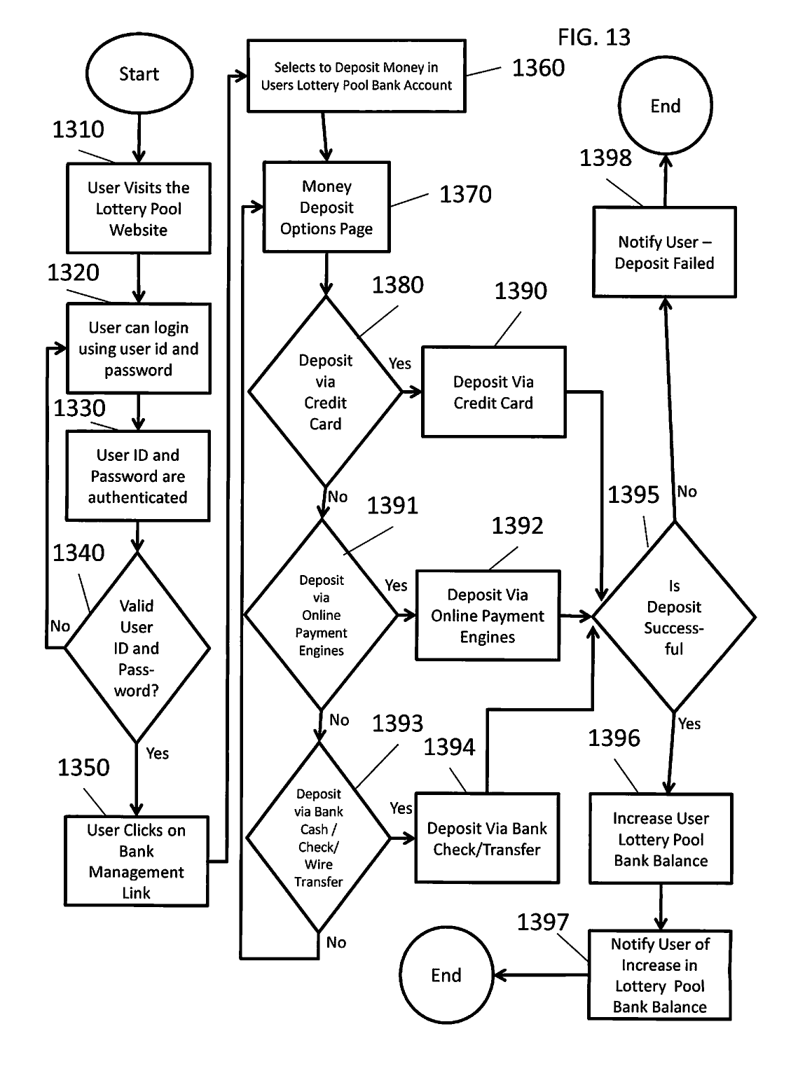

FIG. 13 is a flow diagram showing tasks performed by a lottery pool user with respect to a lottery pool deposit, according to some embodiments. In order to deposit funds in their lottery pool bank account, a registered member visits the web site in block 1310, and then has to log in to the lottery pool site, using their user id and password, as shown in block 1320. A user's user id and password are authenticated against the registration information of users stored at the lottery pool website in block 1330. If the user id and password do not match in an authentication performed in block 1340, the user is asked to enter the user id and password again, and is returned to block 1320.

Once the user is logged in successfully and has successfully been authenticated in block 1340, that user can select an action to manage their lottery pool bank account. As shown in block 1350, this may involve clicking on a bank management link on the lottery pool web page (this is a link that can be provided on the main web page that can be activated once the user is authenticated as a registered user).

One of the actions that the user can perform on the manage bank account page is to deposit funds to the lottery pool bank account for the user, as shown in block 1360.

As the user selects the option to deposit funds to their lottery pool bank account, a money deposit options page is displayed to the user, as shown in block 1370.

One of the options available to the user is to deposit the funds to the user lottery pool bank account is by using a debit card or credit card, as shown in block 1380.

If the user wishes to deposit funds to their lottery pool bank account using a credit card, a deposit funds using credit card is displayed to the user, as shown in block 1390. A user can specify the credit card information and the amount of deposit to their lottery pool bank account.

An option provided to the user is to deposit funds to their lottery pool bank account is using any online payment engines, which can be integrated with the lottery pool web site, as shown in block 1391.

If the user wishes to deposit funds to their lottery pool bank account using online payment engines like Paypal, etc., online deposit information is displayed to the user. A user can specify the payment engine information and the amount of deposit to their lottery pool bank account, as shown in block 1392.

A user can deposit funds to their lottery pool bank account using depositing funds in the lottery pool bank account, or wire transfer from their financial banks, as shown in block 1393.

If the user wishes to deposit funds to their lottery pool bank account using wire transfer from a financial bank, a wire transfer page is displayed to the user. The user can specify the details of their financial bank like the name of account, routing number, bank account number, etc., and the amount of deposit to their lottery bank account, as shown in block 1394.

The user-provided deposit information is validated in block 1395, which performs validation of any of the types of deposits made via blocks 1390, 1392 and 1394. Alternatively this can be a manual validation by the lottery pool management team.

If the deposit was successful, the user's lottery pool bank account is increased by the requested amount of the deposit as shown in block 1396, and the funds are made available once the financial transaction is completed. The user is notified of the successful deposit to their lottery pool bank account as shown in block 1397.

If the financial transaction fails, that is, if the deposit was not successful, the user is notified of the failed bank deposit transaction, as shown in block 1398.

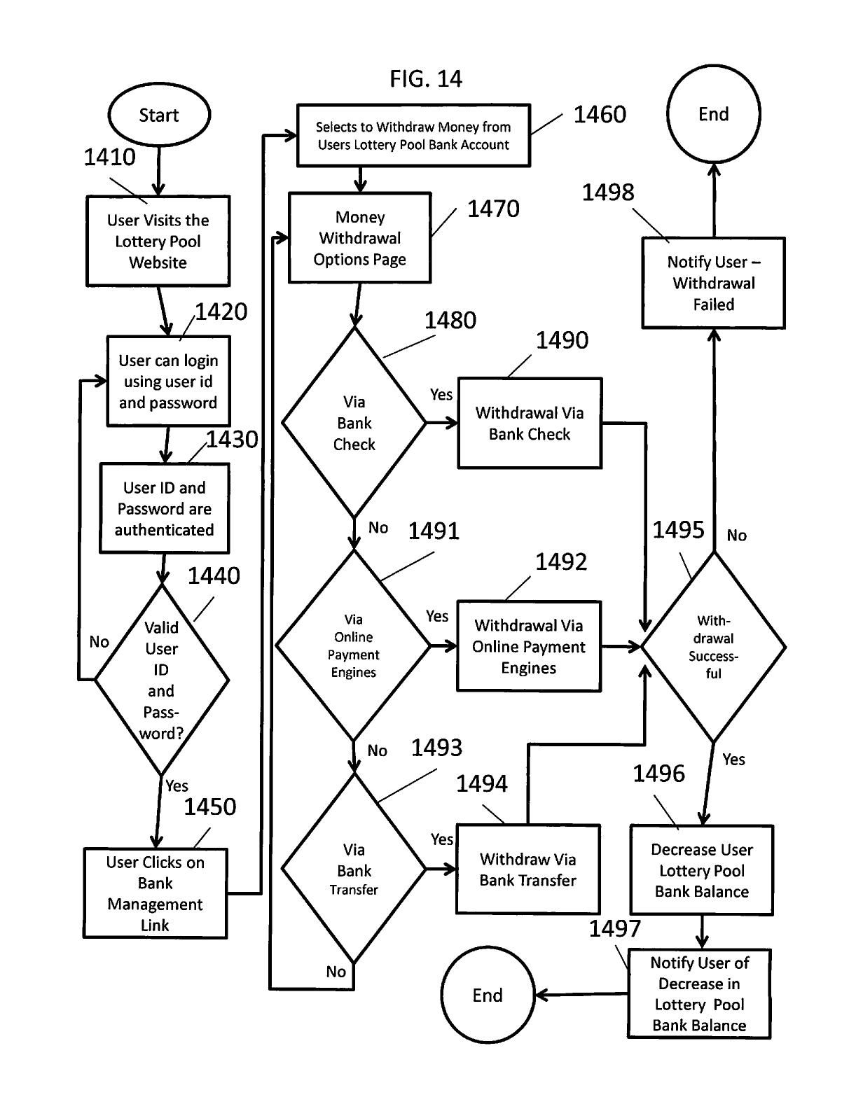

FIG. 14 is a flow diagram showing the tasks performed by a lottery pool user in making a lottery pool bank withdrawal, according to some embodiments. Any registered member with a lottery pool bank balance of greater than $0 can withdraw funds from their lottery pool bank account.

In order to withdraw funds from their lottery pool bank account, a registered member visits the lottery pool website in block 1410, and logs in to the lottery pool site using their user id, and password in block 1420. The user's user id and password are authenticated against the registration information in block 1430. If the user id and password do not match based on a validation procedure performed in block 1440, the user is asked to enter the user id and password again, and is returned to block 1420.

If the user has successfully logged in, he/she can select the action to manage their lottery pool bank account, as shown in block 1450. This can involve the user clicking on a bank management link on the lottery pool website main page, for example.

From the manage bank account page, the user can select an action to withdraw funds from their lottery pool bank account, as shown in block 1460.

The possible funds withdrawal actions available to the user and then displayed on a withdrawal options page, illustrating the withdrawal options for the registered member, as shown in block 1470.

The user can select to withdraw the funds from their lottery pool bank account via a bank check, as shown in block 1480. The user is then presented with a web page to provide and confirm the details of the amount of funds to be withdrawn from user lottery pool bank account, as shown in block 1490. The funds can be sent, for example, to the user's registered mailing address.

The user can alternatively select to withdraw the funds from their lottery pool bank account via payment engines integrated with lottery pool. Example of payment engines are PayPal, etc., as shown in block 1491. The user is then presented with a web page to provide and confirm the details of the payment engines, and the amount of funds to be withdrawn from user lottery pool bank account, as shown in block 1492.

The user can alternatively select to withdraw the funds from their lottery pool bank account via bank wire transfer, as shown in block 1493. A web page is then displayed where the user can specify the details of the bank account the funds will sent to, as shown in block 1494.

A manual determination is then made as to whether the withdrawal transaction is successful, as shown in block 1495, and if so, the user's lottery pool bank account is reduced by the amount of funds withdrawn from the lottery pool bank account, as shown in block 1496. Once the withdrawal is confirmed, a notification is sent to the registered member of the withdrawal transaction, as shown in block 1497.

If the withdrawal transaction was not successful, then the user is notified of the unsuccessful withdrawal transaction in block 1498.

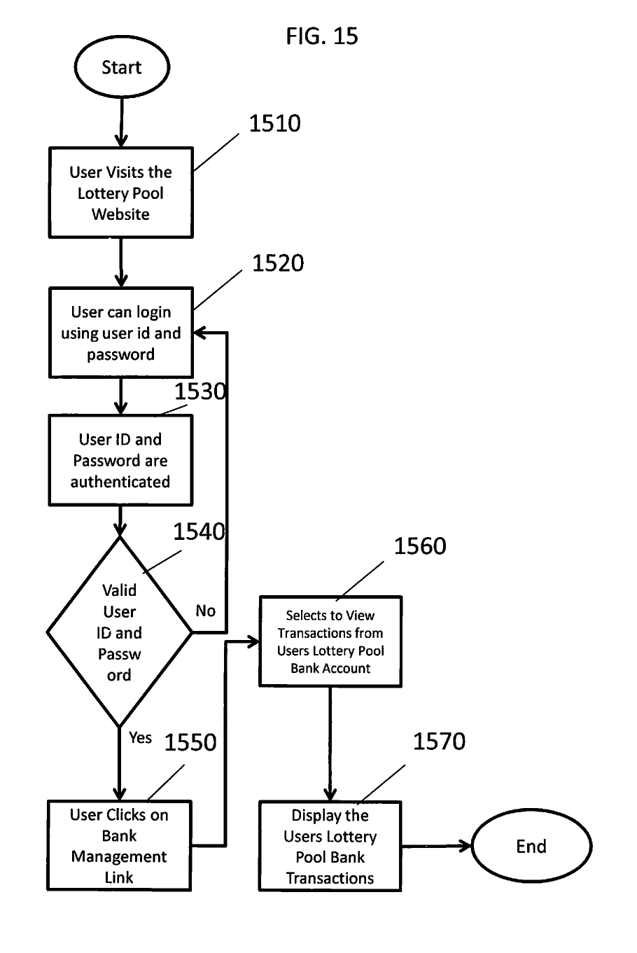

FIG. 15 is a flow diagram showing a lottery pool user performing a lottery pool bank transaction from a list of possible transactions, according to some embodiments, in which any registered member with a lottery pool bank account can review the transactions in their lottery pool bank account.

In order to review the transaction from their lottery pool bank account, a registered member visits the lottery pool web site in block 1510, and then logs in to the lottery pool site, using their user id and password, in block 1520. The user's user id and password are authenticated against the registration information stored at the lottery pool website, as shown in block 1530. If the validation performed in block 1540 is such that the user id and password do not match, the user is asked to enter the user id and password again, and is returned to block 1520.

If the validation in block 1540 is successful and the user has logged in successfully, the user can select the action to manage their lottery pool bank account, and is provided with a bank management link on the lottery pool website, as shown in block 1550.

From the manage bank account page, the user selects the action to view transactions from their lottery pool bank account, as shown in block 1560. The user is then presented with the list of all the transactions on their lottery pool bank account, as shown in block 1570.

In some possible variations of the embodiments described above, the lottery pool website may allow a registered user to provide the lottery pool numbers to be purchased for a lottery associated with a lottery pool for which the registered user has purchased one or more slots. The selection of one of the registered users may be based on a random selection of the registered users in that pool, or it may be based on the registered user who has purchased the most slots in a pool, or it may be based on allocating lottery pools having a criteria in which, in the lottery pool agreement associated with those lottery pools, numbers are to be selected by a member of the pool and not randomly selected by a lottery pool management person purchasing tickets from a retailer. This may provide additional enjoyment to users of the lottery pool system, whereby they may have the ability to provide the numbers for the lottery pool that they have purchased a slot or slots in. If a user does not like the idea of other users selecting numbers to be used for an upcoming lottery, that user may select a lottery pool in which the tickets are to be purchased by the lottery pool system, without number input from any of the users who purchased slots in that lottery pool (as set forth in the lottery pool agreement associated with that lottery pool).

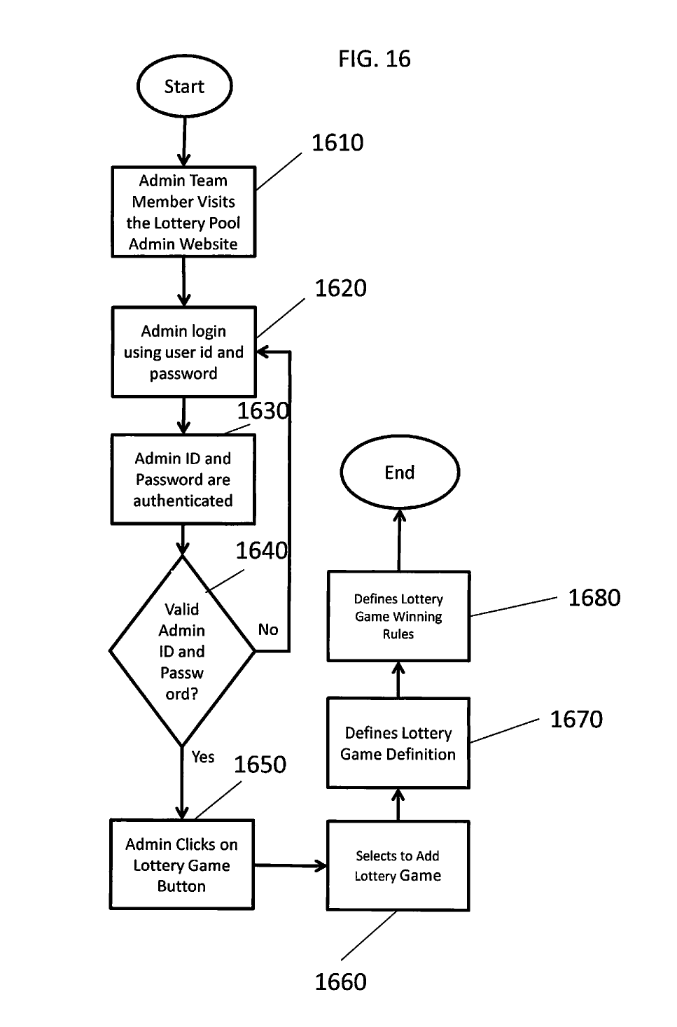

FIG. 16 is a flow diagram showing a lottery game definition according to some embodiments. In block 1610, an administrative team member visits the lottery pool administration website. In block 1620, the administrative team member logs into the website using his/her user ID and password. The user ID and password are authenticated in block 1630, and in block 1640 it is determined whether the user ID and password are valid for an administrative team member. If yes, then the process proceeds to block 1650, and if no, the process goes back to block 1620 for the member to try again to log in as an administrative team member. In block 1650, the administrative team member who has successfully logged in to the website clicks on a lottery game button provided on the website. In block 1660, the administrative team member makes a selection to add a lottery game to the website. In block 1670, the lottery game definition is defined, as input to the website by the administrative team member who added the lottery game. In block 1680, the lottery game rules are defined, as input to the website by the administrative team member who added the lottery game. The lottery game definition process then ends, in which members are then able to purchase a spot or spots in the lottery pool that has been created.

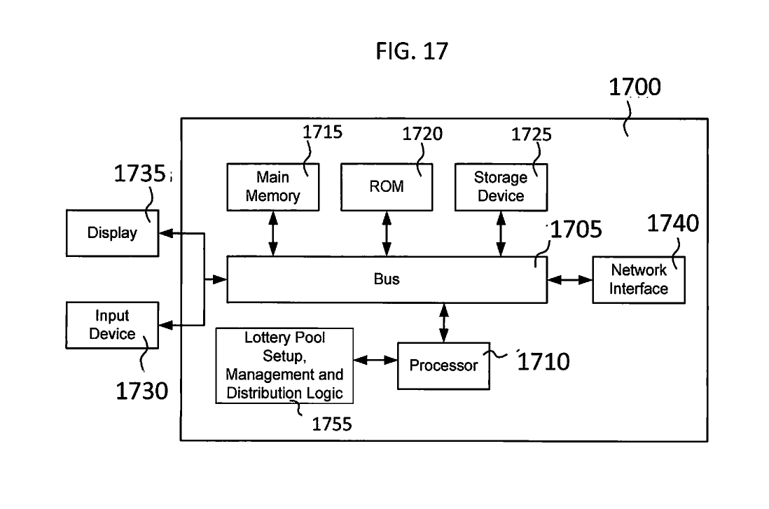

FIG. 17 illustrates a depiction of a computing system 1700 that can perform lottery pool setup, management and winnings distribution according to the embodiments described above. The computing system 1700 includes a bus 1705 or other communication mechanism for communicating information and a processor 1710 coupled to the bus 1705 for processing information. The computing system 1700 also includes main memory 1715, such as a random access memory (RAM) or other dynamic storage device, coupled to the bus 1005 for storing information, and instructions to be executed by the processor 1710. The tools described by way of flow charts of FIGS. 2-15 may be stored in the main memory 1715 or in the storage device 1725, for example. Main memory 1715 can also be used for storing position information, temporary variables, or other intermediate information during execution of instructions by the processor 1710. The computing system 1700 may further include a read only memory (ROM) 1720 or other static storage device coupled to the bus 1705 for storing static information and instructions for the processor 1710. A storage device 1725, such as a solid state device, magnetic disk or optical disk, is coupled to the bus 1705 for persistently storing information and instructions. Network interface 1740 provides a connection to a network, such as the Internet or a Local Area Network (LAN) or a Wide Area Network (WAN). Lottery Pool Setup, Management and Winning Distribution logic 1755, which may be stored in main memory 1715, ROM 1720 and/or storage device 1725, and which also may include some hardware logic components, is utilized by processor 1710 to perform the web-based lottery pool management described above with respect to various embodiments.

The computing system 1700 may be coupled via the bus 1705 to a display 1735, such as a liquid crystal display, or active matrix display, for displaying information to a user. An input device 1730, such as a keyboard including alphanumeric and other keys, may be coupled to the bus 1705 for communicating information, and command selections to the processor 1710. In another implementation, the input device 1730 has a touch screen display 1735. The input device 1730 can include a cursor control, such as a mouse, a trackball, or cursor direction keys, for communicating direction information and command selections to the processor 1710 and for controlling cursor movement on the display 1735.

It will be appreciated that the embodiments described above and illustrated in the drawings represent only a few of the many ways of implementing embodiments for providing lottery pool setup, management and winning distribution.

The environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop compatible, laptop, PDA, mobile devices, etc.), and may include any commercially available operating system and any combination of commercially available and custom software (e.g., browser software, communications software, server software, etc.). These systems may include any types of monitors and input devices (e.g., keyboard, mouse, voice recognition, etc.) to enter and/or view information.

It is to be understood that the software of the present invention embodiments may be implemented in any desired computer language and could be developed by one of ordinary skill in the computer arts based on the functional descriptions contained in the specification and flow charts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flow charts may be modified in any manner that accomplishes the functions described herein. In addition, the functions in the flow charts or description may be performed in any order that accomplishes a desired operation.

The software of the present invention embodiments may be available on a recordable or computer useable medium (e.g., magnetic or optical mediums, magneto-optic mediums, floppy diskettes, CD-ROM, DVD, memory devices, etc.) for use on stand-alone systems or systems connected by a network or other communications medium.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information (e.g., lottery location information, lottery begin time information, lottery drawing time information, registered users personal information, etc.). The database system may be implemented by any number of any conventional or other databases, data stores or storage structures (e.g., files, databases, data structures, data or other repositories, etc.) to store information. The database system may be included within or coupled to the server and/or client systems. The database systems and/or storage structures may be remote from or local to the computer or other processing systems, and may store any desired data (e.g., lottery location information, lottery begin time information, lottery drawing time information, registered users personal information, etc.). Further, various may be implemented by any conventional or other data structures (e.g., files, arrays, lists, stacks, queues, etc.) to store information, and may be stored in any desired storage unit (e.g., database, data or other repositories, etc.).

The present invention embodiments are not limited to the specific tasks or algorithms described above, but may be utilized for improving the performance of hash tables other than open addressing hash tables.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a tangible (non-transitory) computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java (Java and all Java-based trademarks and logos are trademarks of Sun Microsystems, Inc. in the United States, other countries, or both), Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. In alternative implementations in which a lottery allows lottery pool tickets to be purchased electronically (e.g., over the internet), the lottery pool management team of the lottery pool website would make such ticket purchases online, without requiring a person to physically go to a location (e.g., a retailer) to purchase tickets, and in which the tickets, once purchased, are then scanned and displayed on the lottery pool web site for viewing by the members of the lottery pool prior to the actual lottery pool drawing.

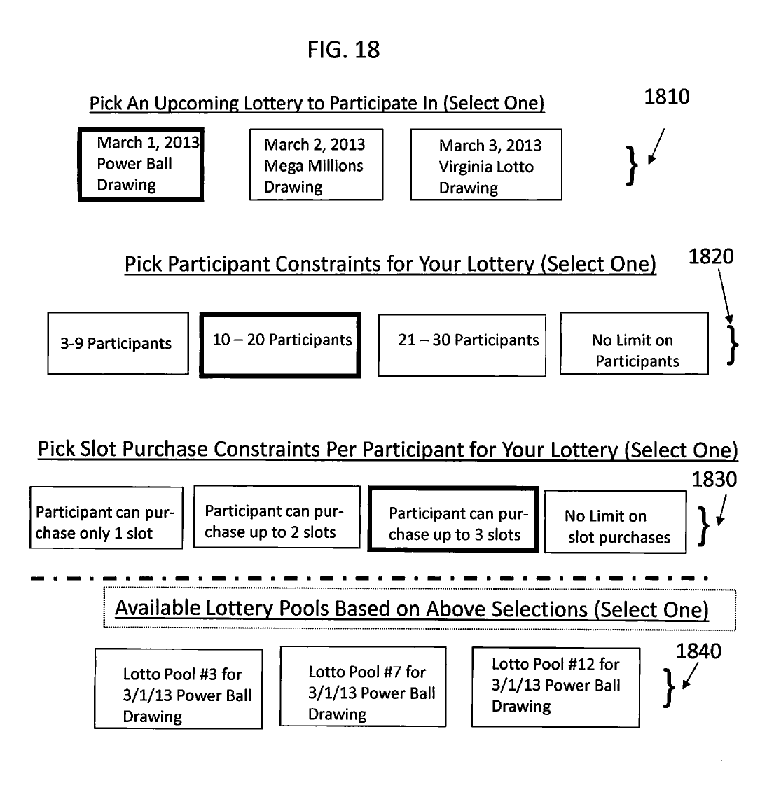

By way of example, referring now to FIG. 18, which shows a graphical user interface screen implemented as a web page on the lottery pool website, after a member has registered onto the website, the member is then provided with a web page as shown in FIG. 18. The member can then select in a first region 1810 of the web page an upcoming lottery drawing from a list of drawings available to that member (e.g., based on the registration information provided by the member, and based on location information of that user such as obtained from the user's browser). The member can also select, in a second region 1820 and a third region 1830 of the web page, participant constraints for the lottery pool, which may include the number of participants in the pool and the number of slots that can be purchased by any one participant in the lottery pool. The selections made by the member are shown by the thicker-lined boxes in FIG. 18. In a fourth region 1840 of the web page the member is provided with a list of lottery pools that meet the selections made by the member for the type of lottery pool that he/she wants to participate in (the available lottery pools only appearing on the web page after the user has made his/her constraint selections as discussed above). If there are no available lottery pools meeting the member's constraints, the member is notified in the fourth region 1840 of this (“NO LOTTERY POOL MEETS YOUR SELECTIONS”), and in some implementations is provided with a list of upcoming lottery pools (e.g., 3 or 4) that most closely meet the constraints selected by the member. If there are more than 3 pools for possible selection, the web page includes a link for the member to view more than the 3 pools shown in the web page of FIG. 18 (e.g., a “MORE SELECTIONS—CLICK HERE” link in the fourth region 1840).

What is claimed is:

1. A lottery pool server, comprising:
a memory accessible by the server and configured to store information regarding at least one lottery drawing to be conducted in the future; and
the server including a processor that performs the following lottery pool management functions:
determines which users have registered to enter the at least one lottery drawing and combines respective lottery entry fees of the registered users as a collective lottery entry pool;
determines when to close an entry period for users to enter into the collective lottery entry pool;
outputs a notification for tickets to be purchased based on the combined lottery entry fees of the collective lottery entry pool provided by the users who have registered to enter the at least one lottery drawing; and
determines, after the lottery drawing has completed, whether or not the collective lottery entry pool has any winnings and if there are winnings the winnings are to be distributed to the registered users who are part of the collective lottery entry pool that won.

2. The lottery pool server according to claim 1, wherein the processor determines a winnings amount to be distributed to the registered users after the lottery drawing has completed based on an amount of lottery entry fees provided by each respective user to the lottery entry pool.

3. The lottery pool server according to claim 1, wherein the processor is further configured to:
determines whether a lottery pool to be managed is a public pool or a private pool; and
when the determination is that the lottery pool is a public pool, allows up to a predetermined number of registered users to enter into the public pool; and
when the determination is that the lottery pool is a private pool, determines whether each registered user who seeks entry into the private pool is authorized to do so, and if so, allows each authorized user to enter into the private pool.

4. The lottery pool server according to claim 1, wherein the processor is further configured to:
for each lottery drawing to be managed, determines user eligibility requirements for entering into the respective lottery drawing.

5. The lottery pool server according to claim 4, wherein the user eligibility requirements include at least one of user age, and user domicile.

6. The lottery pool server according to claim 1, wherein the processor is further configured to:
receives input from a user with respect to creation of a private pool for the at least one lottery drawing, the input including names or email addresses of users who are allowed to enter into the private pool; and
for each user who seeks entry into the private pool, compares personal information of each user as obtained from a registration of each user to determine whether each user is allowed entry into the private pool.

7. The lottery pool server according to claim 1, wherein the processor is further configured to:
after purchasing the tickets for the at least one lottery drawing but before the at least one lottery drawing has been conducted, displays information regarding tickets purchased for the at least one drawing using proceeds of the collective lottery entry pool.

8. The lottery pool server according to claim 7, wherein the information regarding the tickets is displayed on a web page that is accessible by each registered user of the collective lottery entry pool.

9. A computer-implemented method of creating and managing a web-based lottery pool, comprising:
storing information regarding at least one lottery drawing to be conducted in the future; and
determining which users have registered to enter the at least one lottery drawing and combines respective lottery entry fees of the registered users as a collective lottery entry pool;
determining when to close an entry period for users to enter into the collective lottery entry pool;
outputs a notification for tickets to be purchased based on the combined lottery entry fees of the collective lottery entry pool provided by the users who have registered to enter the at least one lottery drawing; and
determining, after the lottery drawing has completed, whether or not the collective lottery entry pool has any winnings and if there are winnings the winnings are to be distributed to the registered users who are part of the collective lottery entry pool that won.

10. The computer-implemented method according to claim 9, wherein the determining of a winnings amount to be distributed to the registered users after the lottery drawing has completed is based on an amount of lottery entry fees provided by each respective user to the lottery entry pool.

11. The computer-implemented method according to claim 9, further comprising:
determining whether a lottery pool to be managed is a public pool or a private pool; and
when the determination is that the lottery pool is a public pool, allowing up to a predetermined number of registered users to enter into the public pool; and
when the determination is that the lottery pool is a private pool, determining whether each registered user who seeks entry into the private pool is authorized to do so, and if so, allows each authorized user to enter into the private pool.

12. The computer-implemented method according to claim 9, further comprising:
for each lottery drawing to be managed, determining user eligibility requirements for entering into the respective lottery drawing.

13. The computer-implemented method according to claim 12, wherein the user eligibility requirements include at least one of: user age, and user domicile.

14. The computer-implemented method according to claim 9, further comprising:
receiving input from a user with respect to creation of a private pool for the at least one lottery drawing, the input including names or email addresses of users who are allowed to enter into the private pool; and
for each user who seeks entry into the private pool, comparing personal information of each user as obtained from a registration of each user to determine whether each user is allowed entry into the private pool.

15. The computer-implemented method according to claim 9, further comprising:
after purchasing the tickets for the at least one lottery drawing but before the at least one lottery drawing has been conducted, displaying information regarding tickets purchased for the at least one drawing using proceeds of the collective lottery entry pool.

16. The computer-implemented method according to claim 15, wherein the information regarding the tickets is displayed on a web page that is accessible by each registered user of the collective lottery entry pool.

17. An apparatus comprising:
a processor including:
a first determining module configured to determine which users have registered to enter the at least one lottery drawing and combines respective lottery entry fees of the registered users as a collective lottery entry pool;
a second determining module configured to determine when to close an entry period for users to enter into the collective lottery entry pool;
a purchasing module configured to output a notification for tickets to be purchased based on the combined lottery entry fees of the collective lottery entry pool provided by the users who have registered to enter the at least one lottery drawing; and
a third determining module configured to determine, after the lottery drawing has completed, whether or not the collective lottery entry pool has any winnings and if there are winnings the winnings are to be distributed to the registered users who are part of the collective lottery entry pool that won.

18. The apparatus according to claim 17, wherein the processor further comprises:
a fourth determining module configured to determine a winnings amount to be distributed to the registered users after the lottery drawing has completed based on an amount of lottery entry fees provided by each respective user to the lottery entry pool.

19. The apparatus according to claim 17, wherein the processor further comprises:
a fourth determining module configured to determine whether a lottery pool to be managed is a public pool or a private pool; and
when the determination is that the lottery pool is a public pool, the fourth determining module allows up to a predetermined number of registered users to enter into the public pool; and
when the determination is that the lottery pool is a private pool, the fourth determining module determines whether each registered user who seeks entry into the private pool is authorized to do so, and if so, allows each authorized user to enter into the private pool.

20. The apparatus according to claim 17, wherein the processor further comprises:
a fourth determining module configured to, for each lottery drawing to be managed, determine user eligibility requirements for entering into the respective lottery drawing.
